(19) United States
(12) Patent Application Publication
(10) Pub. No.: US 2021/0387386 A1
(43) Pub. Date: Dec. 16, 2021

(54) MULTI-LAYERED SHEET AND TRANSFER MATERIAL

(71) Applicant: Harima Chemicals, Incorporated, Kakogawa-shi, Hyogo (JP)

(72) Inventors: Ryouichi NAKAI, Kakogawa-shi, Hyogo (JP); Yutaka KITAJIMA, Kakogawa-shi, Hyogo (JP); Soichi SHIKANO, Kakogawa-shi, Hyogo (JP)

(73) Assignee: Harima Chemicals, Incorporated, Kakogawa-shi, Hyogo (JP)

(21) Appl. No.: 17/296,741

(22) PCT Filed: Nov. 26, 2019
(86) PCT No.: PCT/JP2019/046107

§ 371 Date: May 25, 2021

(30) Foreign Application Priority Data
Dec. 4, 2018 (JP) 2018-227127

(51) Int. Cl. B29C 45/14; B05D 7/24; B05D 7/04

(52) U.S. Cl. CPC B29C 45/14754; B05D 7/24; B29K 2683/00; B29C 2045/1477; B05D 7/04

(57) ABSTRACT

A multi-layered sheet includes a substrate sheet and a thermally curable layer that is disposed on a surface of the substrate sheet and can be disposed on at least a part of a surface of a mold resin, wherein the thermally curable layer is an uppermost layer of the multi-layered sheet, the thermally curable layer includes a product of active energy ray-curable resin cured or half-cured by active energy ray, and the thermally curable layer has: a thermally reactive group that can react and thermally cure with a material component of the mold resin; and a polysiloxane chain.

### TECHNICAL FIELD

The present invention relates to a multi-layered sheet and a transfer material. In particular, the present invention relates to a multi-layered sheet and a transfer material including the multi-layered sheet.

### BACKGROUND ART

Conventionally, a resin molded article is produced by, for example, injecting melted resin into a mold and curing the resin.

When a resin molded article is produced in such a method, however, there is a disadvantage that the melted resin adheres to the internal surface of the mold and contaminates the mold.

In light of the foregoing, to suppress the adherence of the resin to the mold (mold contamination), for example, application of a mold release agent to the mold has been known.

When the mold release agent is applied to the mold, however, there is a disadvantage that the mold release agent adheres to the produced resin molded article and causes damage to it.

In light of the foregoing, in place of the mold release agent, the usage of a mold release film has been discussed.

More specifically, it has been proposed to place a mold release film made of an elastomer film between the resin molded article and the mold in a resin molded article producing method in which the resin molded article pressed to a mold is demolded from the mold. (for example, see Patent Document 1 below).

Such a method can suppress the adherence of the mold release film to the resin molded article. Differently from the case in which the mold release agent adheres to the resin molded article, when the mold release film adheres to the resin molded article, the mold release film can be peeled from the resin molded article.

### CITATION LIST

Patent Document
Patent Document 1: Japanese Unexamined Patent Publication No. H6-55546

### SUMMARY OF THE INVENTION

### Problem to be Solved by the Invention

However, the elastomer film does not have sufficient releasability from the resin molded article. Thus, for example, the peeling stress may damage the resin molded article or a member sealed in the resin molded article.

In light of the foregoing, to suppress the damage to the resin molded article, it can be considered to use a multi-layered film as the mold release film. That is, while a part of the layers (an uppermost layer) of the multi-layered film is in tight contact with the resin molded article, the rest of the multi-layered film can be peeled.

In such a method, the multi-layered film is placed between the mold and the resin molded article. Thus, the adherence of the resin to the mold is suppressed. Further, by peeling the rest of the layers from the part of the layers of the multi-layered film (interlayer peeling), the film can easily be peeled from the resin molded article.

Meanwhile, for the interlayer releasability, such a case requires the tight contact (tight contact strength) between the resin molded article and the part of the layers of the multi-layered film.

The present invention provides: a multi-layered sheet that can suppress the contamination of the mold during the production of the resin molded article and has a layer with excellent interlayer releasability and in tight contact with the resin molded article; and a transfer material including the multi-layered sheet.

### Means for Solving the Problem

The present invention [1] includes a multi-layered sheet comprising: a substrate sheet; and a layer that is disposed on a surface of the substrate sheet and can be disposed on at least a part of a surface of a mold resin, wherein the layer is an uppermost layer of the multi-layered sheet, the layer includes a product of active energy ray-curable resin cured or half-cured by active energy ray, and the layer has: a thermally reactive group that can react and thermally cure with a material component of the mold resin; and a polysiloxane chain.

The present invention [2] includes the multi-layered sheet described in [1] above, wherein the layer is a protective layer to protect the surface of the mold resin.

The present invention [3] includes the multi-layered sheet described in [1] or [2] above, wherein the thermally reactive group is selected from a group consisting of a hydroxyl group, an epoxy group, a carboxy group, and a (meth)acryloyl group.

The present invention [4] includes the multi-layered sheet described in any one of the above-described [1] to [3], wherein the active energy ray-curable resin contains (meth)acrylic resin having a thermally reactive group, polysiloxane side chain, and an active energy ray-curable group.

The present invention [5] includes the multi-layered sheet described in any one of the above-described [1] to [4], wherein an epoxy equivalent of the active energy ray-curable resin is 1000 g/eq or more and 10000 g/eq or less.

The present invention [6] includes the multi-layered sheet described in any one of the above-described [1] to [5], wherein the active energy ray-curable resin is a reaction product of an intermediate polymer and an active energy ray-curable group-containing compound, the intermediate polymer is produced by a reaction of an intermediate material component including a polysiloxane-containing compound and a thermally reactive group-containing compound, and a glass transition temperature of the intermediate polymer is 0° C. or more and 70° C. or less.

The present invention [7] includes the multi-layered sheet described in any one of the above-described [1] to [6], wherein a weight-average molecular weight of the active energy ray-curable resin is 5000 or more and 100000 or less.

The present invention [8] includes the multi-layered sheet described in any one of the above-described [1] to [7], wherein a material component of the active energy ray-curable resin contains the polysiloxane-containing compound, and a ratio of the polysiloxane-containing compound is, relative to a total amount of the material component of the active energy ray-curable resin, 0.10 mass % or more and 10.0 mass % or less.

The present invention [9] includes a transfer material comprising the multi-layered sheet described in any one of the above-described [1] to [8].

The present invention [10] includes the transfer material described in [9] further comprising a peelable layer disposed on a surface of the layer of the multi-layered sheet.

### Effects of the Invention

In the multi-layered sheet and transfer material of the present invention, the layer includes a product of active energy ray-curable resin cured or half-cured by the active energy ray, and has a thermally reactive group capable of reacting and thermally curing with a material component of the mold resin, and a polysiloxane chain.

Thus, when the transfer material including the multi-layered sheet of the present invention is disposed in a mold and the material component of mold resin is injected into the mold, the mold resin is formed and simultaneously the thermally reactive group of the layer and the material component of the mold resin adhere to each other by their thermal curing reaction. Then, the layer is internally crosslinked (thermally cured), and thus a surface layer (thermally cured layer) is formed from the layer (thermally curable layer). This enables the surface layer (thermally cured layer) to adhere to the mold resin without providing an adhesive layer.

As a result, the surface layer (thermally cured layer) is in excellently tight contact with the mold resin.

In the multi-layered sheet and transfer material of the present invention, the layer (thermally curable layer) has a polysiloxane chain. Thus, the substrate sheet of the multi-layered sheet can easily be peeled from the surface layer (thermally cured layer) and mold resin. This suppresses the damage caused by the peeling stress to the mold resin or a member sealed in the mold resin.

Further, in the multi-layered sheet and transfer material of the present invention, the layer (thermally curable layer) has a polysiloxane chain. This suppresses the adherence of the surface of the layer (thermally curable layer) to the mold when the surface is in contact with the mold. Therefore, the contamination of the mold is suppressed.

### BRIEF DESCRIPTION OF THE DRAWINGS

FIG. 1 is a schematic view showing an embodiment of the multi-layered sheet of the present invention.

FIG. 2 is a schematic view showing a laminated resin molded article produced with the multi-layered sheet in FIG. 1.

FIGS. 3A to 3D are a flow diagram showing an embodiment of a method for producing the laminated resin molded article with the multi-layered sheet of the present invention. FIG. 3A illustrates a preparation step. FIG. 3B illustrates a disposition step. FIG. 3C illustrates a transfer step. FIG. 3D illustrates a peeling step.

FIG. 4 is a schematic view showing another embodiment of the multi-layered sheet of the present invention.

FIG. 5 is a schematic view showing an embodiment in which an anti-mold-adherence layer is disposed on the other surface of the substrate sheet of the multi-layered sheet in FIG. 1.

FIG. 6 is a schematic view showing an embodiment in which an anti-mold-adherence layer is disposed on the other surface of the substrate sheet of the multi-layered sheet in FIG. 4.

### DESCRIPTION OF THE EMBODIMENTS

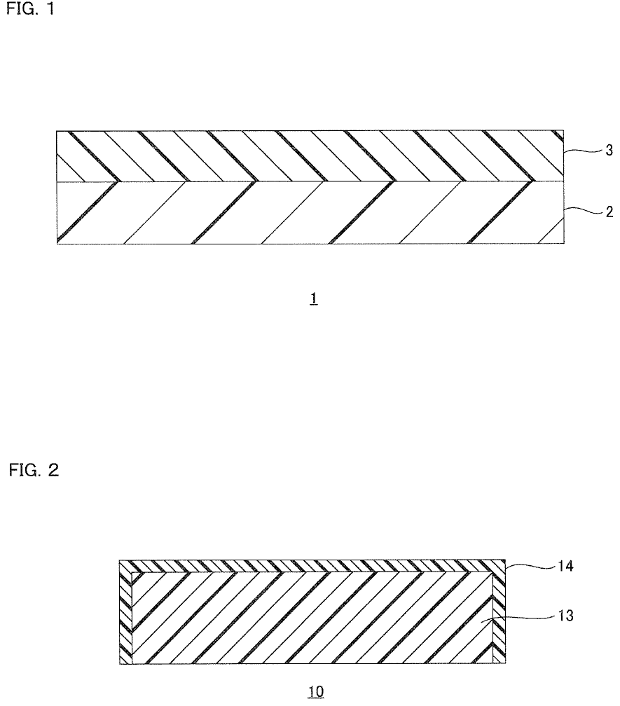

In FIG. 1, a multi-layered sheet 1 does not include an adhesive layer on an uppermost surface and includes a substrate sheet 2 and a thermally curable layer 3 as a layer disposed on a surface of the substrate sheet 2.

Examples of the substrate sheet 2 include: olefin films such as a polyethylene film, a polypropylene film, a poly-1-butene film, a poly-4-methyl-1-pentene film, an ethylene propylene copolymer film, an ethylene 1-butene copolymer film, an ethylene vinyl acetate copolymer film, an ethylene ethyl acrylate copolymer film, and an ethylene vinyl alcohol copolymer film; polyester films such as a polyethylene terephthalate film, a polyethylene naphthalate film, and a polybutylene telephthalate film; polyamide films such as a nylon 6 film, a nylon 6,6 film, and a partially aromatic polyamide film; chlorine-based films such as a polyvinyl chloride film, and a polyvinylidene chloride film; fluorinated films such as an ETFE (tetrafluoroethylene ethylene copolymer) film; and others, for example, plastic films such as a poly(meta)acrylate film, a polystyrene film, and a polycarbonate film.

The substrate sheet 2 can be produced as, for example, a non-oriented film or an oriented film such as a uniaxial oriented film or a biaxial oriented film.

Further, if necessary, the substrate sheets 2 can be subjected to an easily adhesive treatment such as a release treatment using a mold release agent such as a silicone-based, fluorinated, long-chain alkyl-based, or fatty acid amide-based mold release agent, or a silica powder, a stain-resistant treatment, an acid treatment, an alkali treatment, a primer treatment, a corona treatment, a plasma treatment, an ultraviolet treatment, or an electron-beam treatment, or antistatic treatment such as vapor-deposition, spraying, or kneading.

As the substrate sheet 2, preferably, an olefin film, and a fluorinated film are used. And more preferably, an olefin film is used.

The substrate sheet 2 has a thickness of, for example, 5 μm or more, preferably 10 μm or more, and for example, 300 μm or less, preferably 100 μm or less.

The thermally curable layer 3 is an uppermost layer of the multi-layered sheet 1. The thermally curable layer 3 can be in contact with and be disposed on at least a part of a surface of a mold resin 13 (described below). More specifically, the thermally curable layer 3 is a layer before being thermally cured (described below). And the thermally curable layer 3 is disposed as the uppermost surface (the top surface in FIG. 1) of the multi-layered sheet 1 and is exposed.

The thermally curable layer 3 is made of active energy ray-curable resin. More specifically, the thermally curable layer 3 includes a product of active energy ray-curable resin cured or half-cured by active energy ray. Preferably, the thermally curable layer 3 consists of a product of active energy ray-curable resin cured or half-cured with active energy ray.

Examples of the active energy ray-curable resin include resin having a thermally reactive group capable of reacting and thermally curing with a material component of the mold resin described below (hereinafter, referred to as a “mold material”), a polysiloxane chain, and an active energy ray-curable group.

To ensure the tight contact of the thermally curable layer 3 with the mold resin (described below), the thermally reactive group is introduced in the active energy ray-curable resin.

The thermally reactive group (hereinafter, referred to as the “layer-side thermally reactive group”) is a functional group capable of bonding to the thermally reactive group in the mold material (hereinafter, referred to as the “mold-side thermally reactive group”).

More specifically, examples of the layer-side thermally reactive group include a hydroxyl group (hydroxy group), an epoxy group (glycidyl group), a carboxy group, an isocyanate group, an oxetane group, a primary amino group, and a secondary amino group.

The layer-side thermally reactive group is appropriately selected according to the type of the mold-side thermally reactive group.

For example, when the mold-side thermally reactive group (described below) includes an epoxy group, examples of the layer-side thermally reactive group include a hydroxyl group (hydroxy group), an epoxy group (glycidyl group), a carboxy group, an isocyanate group, an oxetane group, a primary amino group, and a secondary amino group.

Alternatively, for example, when the mold-side thermally reactive group (described below) includes a hydroxyl group, examples of the layer-side thermally reactive group include a hydroxyl group (hydroxy group), an epoxy group (glycidyl group), a carboxy group, and an isocyanate group.

Alternatively, for example, when the mold-side thermally reactive group (described below) includes a carboxy group, examples of the layer-side thermally reactive group include a hydroxyl group (hydroxy group) and an epoxy group (glycidyl group).

Alternatively, for example, when the mold-side thermally reactive group (described below) includes an isocyanate group, examples of the layer-side thermally reactive group include a hydroxyl group (hydroxy group) and an epoxy group (glycidyl group).

These layer-side thermally reactive groups may be used singly or in combination of two or more.

The average molarity of the layer-side thermally reactive group contained in the active energy ray-curable resin is appropriately set depending on the purpose and intended use.

A polysiloxane chain is introduced in the active energy ray-curable resin to ensure the interlayer releasability between the thermally curable layer 3 and/or a thermally cured layer 14 and the substrate sheet 2, and further ensure the non-adherence to the mold (or that the mold is uncontaminated).

More specifically, a polysiloxane chain is a repetition unit in terms of which a dialkyl siloxane structure (—(R₂Sio)—(R: an alkyl group with carbons of 1 to 4)) is repeated. The polysiloxane chain is contained in the main chain and/or side chains of the active energy ray-curable resin. Preferably, the polysiloxane chain is contained in the side chains of the active energy ray-curable resin.

In other words, the active energy ray-curable resin preferably contains a polysiloxane side chain.

The repetition unit of a siloxane structure (—(R₂Sio)—) in a polysiloxane chain is not particularly limited and is appropriately set according to the purpose and intended use. The repetition unit of a siloxane structure (—(R₂Sio)—) is, for example, 10 or more, preferably 100 or more, and for example, 300 or less, preferably 200 or less.

The average molarity of the polysiloxane chain contained in the active energy ray-curable resin is appropriately set according to the purpose and intended use.

The active energy ray-curable group is reacted and cured by the irradiation of active energy ray (described below). Examples of the active energy ray-curable group include a (meth) acryloyl group.

The “(meth) acryloyl group” is defined as an “acryloyl group” and/or a “methacryloyl group”.

Similarly, the “(meth)acryl” described below is defined as “acryl” and/or “methacryl”. The “(meth)acrylate” described below is defined as “acrylate” and/or “methacrylate”.

The active energy ray-curable group is preferably a (meth)acryloyl group.

That is, the active energy ray-curable resin preferably contains a (meth)acryloyl group as the active energy ray-curable group. In other words, for the active energy ray-curable resin, preferably, (meth)acrylic resin is used.

The average molarity of the active energy ray-curable group contained in the active energy ray-curable resin is appropriately set according to the purpose and intended use.

For easy manufacturing, as the active energy ray-curable resin, preferably, (meth)acrylic resin having the layer-side thermally reactive group, a polysiloxane chain (main chain or side chain), and the active energy ray-curable group are used. More preferably, (meth)acrylic resin having the layer-side thermally reactive group, a polysiloxane side chain, and the active energy ray-curable group are used.

To produce (meth)acrylic resin having the layer-side thermally reactive group, a polysiloxane side chain, and the active energy ray-curable group, for example, as described below, (meth)acrylic resin having the layer-side thermally reactive group and a polysiloxane chain without the active energy ray-curable group (hereinafter, referred to as an “intermediate polymer”) is first produced, and the active energy ray-curable group is subsequently introduced into the produced intermediate polymer.

More specifically, in this method, polymerizable components including a polysiloxane-containing compound and a thermally reactive group-containing compound are first polymerized to produce a polymer (intermediate polymer) without an active energy ray-curable group.

Examples of the polysiloxane-containing compound include a compound having a polysiloxane group and a (meth)acryloyl group in combination.

More specifically, examples of the polysiloxane-containing compound include a polysiloxane-containing (meth)acrylic compound such as 3-(meth) acryloylpropyldimethylpolysiloxane or 3-(meth)acryloylpropylphenylmethylpolysiloxane.

These polysiloxane-containing compounds may be used singly or in combination of two or more.

For the polysiloxane-containing compound, preferably, 3-(meth) acryloylpropyldimethylpolysiloxane is used. More preferably, 3-meth acryloylpropyldimethylpolysiloxane is used.

The content of the polysiloxane-containing compound relative to a total amount of the polymerizable component is, for example, 0.05 mass % or more, preferably 0.1 mass % or more, and for example, 20 mass % or less, preferably 10 mass % or less.

Examples of the thermally reactive group-containing compound include a hydroxyl group-containing polymerizable compound, an epoxy group-containing polymerizable compound, a carboxy group-containing polymerizable compound, an isocyanate group-containing polymerizable compound, an oxetane group-containing polymerizable compound, and a primary amino group-containing polymerizable compound, and a secondary amino group-containing polymerizable compound.

Examples of the hydroxyl group-containing polymerizable compound include hydroxyl group-containing (meth)acrylate such as hydroxymethyl (meth)acrylate, 2-hydroxyethyl (meth)acrylate, 3-hydroxypropyl (meth)acrylate, 1-methyl-2-hydroxyethyl (meth)acrylate, 2-hydroxypropyl (meth)acrylate, and 4-hydroxybutyl (meth)acrylate. These can be used singly, or can be used in combination of two or more.

Examples of the epoxy group-containing polymerizable compound include epoxy group-containing (meth)acrylic compound such as glycidyl (meth)acrylate. These can be used singly, or can be used in combination of two or more.

Examples of the carboxy group-containing polymerizable compound include α,β-unsaturated carboxylic acid such as (meth)acrylic acid, itaconic acid, maleic acid, and fumaric acid or a salt thereof.

These can be used singly, or can be used in combination of two or more.

Examples of the isocyanate group-containing polymerizable compound include isocyanate group-containing (meth)acrylic compounds such as isocyanatomethyl (meth)acrylate, 2-isocyanatoethyl (meth)acrylate, 3-isocyanatopropyl (meth)acrylate, 1-methyl-2-isocyanatoethyl (meth)acrylate, 2-isocyanatopropyl (meth)acrylate, and 4-isocyanatobutyl (meth)acrylate. These can be used singly, or can be used in combination of two or more.

Examples of the oxetane group-containing polymerizable compound include oxetane group-containing (meth)acrylic compounds such as (3-ethyloxetane-3-yl)methyl (meth)acrylate. These can be used singly, or can be used in combination of two or more.

Examples of the primary amino group-containing polymerizable compound include primary amino group-containing (meth)acrylic compounds such as aminoethyl (meth)acrylate and aminopropyl (meth)acrylate. These can be used singly, or can be used in combination of two or more.

Examples of the secondary amino group-containing polymerizable compound include secondary amino group-containing (meth)acrylic compounds such as monomethylaminoethyl (meth)acrylate, monobutylaminoethyl (meth)acrylate, monomethylaminopropyl (meth)acrylate, and monobutylaminopropyl (meth)acrylate.

These thermally reactive group-containing compounds can be used singly, or can be used in combination of two or more.

For the thermally reactive group-containing compound, preferably, a hydroxyl group-containing polymerizable compound, an epoxy group-containing polymerizable compound, and a carboxy group-containing polymerizable compound are used.

The content of the thermally reactive group-containing compound relative to a total amount of the polymerizable component is, for example, 30 mass % or more, preferably 50 mass % or more, and for example, 90 mass % or less, preferably 80 mass % or less.

The polymerizable component can further include another polymerizable compound containing neither a polysiloxane chain nor a thermally reactive group (hereinafter, referred to as “other polymerizable compounds”).

Examples of the other polymerizable compounds include (meth)acrylic acid ester and an aromatic ring-containing polymerizable compound.

Examples of the (meth)acrylic acid ester include a straight-chain, branched, or cyclic alkyl (meth)acrylate monomer having 1 to 30 carbon atoms such as methyl (meth)acrylate, ethyl (meth)acrylate, n-propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, neopentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, isononyl (meth)acrylate, decyl (meth)acrylate, dodecyl (meth)acrylate, tridecyl (meth)acrylate, tetradecyl (meth)acrylate, 1-methyltridecyl (meth)acrylate, hexadecyl (meth)acrylate, octadecyl (meth)acrylate (stearyl (meth)acrylate), isostearyl (meth)acrylate, eicosyl (meth)acrylate, docosyl (meth)acrylate (behenyl (meth)acrylate), tetracosyl (meth)acrylate, triacontyl (meth)acrylate, and cyclohexyl (meth)acrylate. These can be used singly, or can be used in combination of two or more.

Examples of the aromatic ring-containing polymerizable compound include an aromatic ring-containing (meth)acrylate such as phenyl (meth)acrylate, benzyl (meth)acrylate, phenoxyethyl (meth)acrylate, (meth)acrylic acid phenoxydiethylene glycol, o-phenylphenoxyethyl (meth)acrylate, and phenoxybenzyl (meth)acrylate, and a styrene-based monomer such as styrene and α-methylstyrene. These can be used singly, or can be used in combination of two or more.

For the other polymerizable compounds, preferably, (meth)acrylic acid ester is used.

The content of another polymerizable compound relative to a total amount of the polymerizable component is, for example, 20 mass % or more, preferably 30 mass % or more, and for example, 60 mass % or less, preferably 50 mass % or less.

To polymerize the polymerizable components, for example, the above-described polymerizable component is mixed at the above-described ratio in a solvent, is heated and polymerized under the presence of a known radical polymerization initiator (for example, an azo-based compound, or a peroxide compound).

Examples of the solvent are not particularly limited as long as the solvent is stable with the polymerizable component. Examples of the solvent include organic solvents such as petroleum-based hydrocarbon solvents including hexane and mineral spirit; aromatic hydrocarbon solvents including benzene, toluene, and xylene; ketone solvents including acetone, methyl ethyl ketone, methyl isobutyl ketone, diisobutyl ketone, and cyclohexanone; ester solvents including methyl acetate, ethyl acetate, butyl acetate, γ-butyrolactone, and propylene glycol monomethyl ether acetate; and non-protonic polar solvents including N,N-dimethylformamide, N,N-dimethylacetoamide, dimethylsulfoxide, N-methylpyrrolidone, and pyridine.

Further, examples of the solvent include aqueous solvents such as water; alcohol solvents including methanol, ethanol, propanol, isopropanol, and butanol; and glycol ether solvents including ethylene glycol monoethyl ether and propylene glycol monomethyl ether.

As the solvent, a commercially available product is also used. To be specific, as the petroleum-based hydrocarbon solvent, for example, AF Solvent No. 4 to No. 7 (hereinabove, manufactured by Nippon Oil Corporation) are used and as the aromatic hydrocarbon solvent, for example, Ink Solvent No. 0 (hereinabove, manufactured by Nippon Oil Corporation) and Solvesso 100, 150, and 200 manufactured by Exxonmobil Corporation are used.

These solvents may be used singly or in combination of two or more.

The mixing ratio of the solvent is not particularly limited, and is appropriately set according to the purpose and intended use.

The polymerization conditions differ depending on the formulation of the polymerizable component or the type of the radical polymerization initiator. For example, the polymerization temperature is 30° C. or higher, preferably 60° C. or higher, and for example, 150° C. or lower, preferably 120° C. or lower. The polymerization time is, for example, 2 hours or longer, preferably 4 hours or longer, and for example, 20 hours or shorter, preferably 8 hours or shorter.

In this manner, as the intermediate polymer, (meth)acrylic resin without the active energy ray-curable group is produced.

In other words, the intermediate polymer is a reaction product of an intermediate material component (a primary material component) that includes the polysiloxane-containing compound and the thermally reactive group-containing compound and does not include the active energy ray-curable group-containing compound.

Preferably, the intermediate polymer is produced as a solution and/or dispersion.

In such a case, the solid content (non-volatile content) concentration of the solution and/or dispersion of the intermediate polymer is, for example, 5 mass % or more, preferably 10 mass % or more, and for example, 60 mass % or less, preferably 50 mass % or less.

Further, if necessary, the solvent is added or removed so that the solid content (non-volatile content) concentration of the intermediate polymer can be adjusted in the above-described range, and thus the viscosity of the solvent and/or dispersion of the intermediate polymer can be adjusted.

The viscosity (25° C.) of the 30 mass % solvent of the intermediate polymer is, for example, 1 mPa s or more, preferably 5 mPa s or more, and for example, 800 mPa s or less, preferably 400 mPa s or less.

The measuring method of the viscosity is in accordance with Examples described below (the same applies hereinafter).

Further, the weight-average molecular weight (GPC measurement: in the conversion to polystyrene) of the intermediate polymer is, for example, 5000 or more, preferably 10000 or more, and for example, 100000 or less, preferably 50000 or less.

Further, the number-average molecular weight (GPC measurement: in the conversion to polystyrene) of the intermediate polymer is, for example, 1000 or more, preferably 5000 or more, and for example, 50000 or less, preferably 30000 or less.

The measuring methods of the weight-average molecular weight and the number-average molecular weight is in accordance with Examples described below (the same applies hereinafter).

For the abrasion-resistance (described below), the glass transition temperature of the intermediate polymer is, for example, 0° C. or higher, preferably 5° C. or higher, more preferably 15° C. or higher, further more preferably 20° C. or higher, and for example, 70° C. or lower, preferably 60° C. or lower, more preferably 45° C. or lower, further more preferably 35° C. or lower.

The measuring method of the glass transition temperature of the intermediate polymer is in accordance with Examples described below (the same applies hereinafter).

Furthermore, the acid value of the intermediate polymer is, for example, 0.01 mgKOH/g or more, preferably 0.05 mgKOH/g or more, and for example, 200 mgKOH/g or less, preferably 100 mgKOH/g or less.

The measuring method of the acid value of the intermediate polymer is in accordance with Examples described below (the same applies hereinafter).

Alternatively, when the polymerizable component contains the hydroxyl group-containing polymerizable compound, the hydroxyl value of the intermediate polymer is, for example, 10 mgKOH/g or more, preferably 20 mgKOH/g or more, and for example, 90 mgKOH/g or less, preferably 80 mgKOH/g or less.

Note that the measuring method of the hydroxyl value is in accordance with the examples described below (the same applies hereinafter).

Alternatively, when the polymerizable component contains the epoxy group-containing polymerizable compound, the epoxy equivalent of the intermediate polymer is, for example, 300 g/eq or more, preferably 500 g/eq or more, and for example, 2000 g/eq or less, preferably 1500 g/eq or less.

The measuring method of the epoxy equivalent is in accordance with Examples described below (the same applies hereinafter).

Next, in this method, the intermediate polymer produced as described above is reacted with the active energy ray-curable group-containing compound to introduce the active energy ray-curable group into the intermediate polymer. This produces the (meth)acrylic resin having the active energy ray-curable group in its side chain.

Examples of the active energy ray-curable group-containing compound include the above-described hydroxyl group-containing (meth)acrylic compound, the above-described epoxy group-containing (meth)acrylic compound, the above-described α,β-unsaturated carboxylic acid, the above-described isocyanate group-containing (meth)acrylic compound, the above-described oxetane group-containing (meth)acrylic compound, the above-described primary amino group-containing (meth)acrylic compound, and the above-described secondary amino group-containing (meth)acrylic compound.

These can be used singly, or can be used in combination of two or more.

The active energy ray-curable group-containing compound is appropriately selected according to the thermally reactive group included in the intermediate polymer.

That is, the active energy ray-curable group-containing compound reacts with a part of the thermally reactive group included in the intermediate polymer and they bond to each other. This introduces the active energy ray-curable group into the intermediate polymer and consequently produces the active energy ray-curable resin.

Accordingly, in this method, the active energy ray-curable group-containing compound having a functional group (thermally reactive group) bondable to the thermally reactive group in the intermediate polymer is selected.

For example, when the intermediate polymer contains the epoxy group as the thermally reactive group, a functional group (reactive group) capable of reacting with the epoxy group is selected as the thermally reactive group in the active energy ray-curable group-containing compound. Specific examples of such an active energy ray-curable group include a hydroxyl group, an epoxy group, a carboxy group, an isocyanate group, an oxetane group, a primary amino group, and a secondary amino group. Meanwhile, an active energy ray-curable group-containing compound having a functional group (reactive group) capable of reacting with the epoxy group is selected as the active energy ray-curable group-containing compound. Specific examples of the active energy ray-curable group-containing compound include a hydroxyl group-containing (meth)acrylic compound, an epoxy group-containing (meth)acrylic compound, α,β-unsaturated carboxylic acid, an isocyanate group-containing (meth)acrylic compound, an oxetane group-containing (meth)acrylic compound, a primary amino group-containing (meth)acrylic compound, and a secondary amino group-containing (meth)acrylic compound, and preferably α,β-unsaturated carboxylic acid is used.

Alternatively, when the intermediate polymer contains a hydroxyl group as the thermally reactive group, examples of the thermally reactive group in the active energy ray-curable group-containing compound include a hydroxyl group, an epoxy group, a carboxy group, and an isocyanate group. Meanwhile, examples of the active energy ray-curable group-containing compound include a hydroxyl group-containing (meth)acrylic compound, an epoxy group-containing (meth)acrylic compound, α,β-unsaturated carboxylic acid, and an isocyanate group-containing (meth)acrylic compound. Preferably an isocyanate group-containing (meth)acrylic compound is used.

Alternatively, when the intermediate polymer contains a carboxy group as the thermally reactive group, examples of the thermally reactive group in the active energy ray-curable group-containing compound include a hydroxyl group and an epoxy group. Meanwhile, examples of the active energy ray-curable group-containing compound include a hydroxyl group-containing (meth)acrylic compound and an epoxy group-containing (meth)acrylic compound. Preferably, an epoxy group-containing (meth)acrylic compound is used.

Alternatively, when the intermediate polymer contains an isocyanate group as the thermally reactive group, examples of the thermally reactive group in the active energy ray-curable group-containing compound include a hydroxyl group and an epoxy group. Meanwhile, examples of the active energy ray-curable group-containing compound include a hydroxyl group-containing (meth)acrylic compound and an epoxy group-containing (meth)acrylic compound. Preferably a hydroxyl group-containing (meth)acrylic compound is used.

The active energy ray-curable group-containing compound selected as described above bonds to a part of the thermally reactive group in the intermediate polymer. This introduces the active energy ray-curable group into the intermediate polymer.

The mixing ratio of the active energy ray-curable group-containing compound is appropriately selected so that the thermally reactive group in the intermediate polymer remains unreacted (free).

More specifically, relative to 100 moles of the thermally reactive group in the intermediate polymer, the thermally reactive group in the active energy ray-curable group-containing compound is, for example, 10 moles or more, preferably 20 moles or more, and for example, 90 moles or less, preferably 80 moles or less.

In the reaction at the ratio described above, the thermally reactive group in the intermediate polymer remains without bonding to the thermally reactive group in the active energy ray-curable group-containing compound.

As a result, the thermally reactive group remaining in the intermediate polymer ensures its thermally reactive property with a mold material (described below).

In the reaction of the intermediate polymer with the active energy ray-curable group-containing compound, for example, the intermediate polymer is blended with the active energy ray-curable group-containing compound so that the thermally reactive group in the intermediate polymer is blended with the thermally reactive group in the active energy ray-curable group-containing compound at the above-described ratio. Then, the mixture is heated under the presence of known catalyst and solvent if necessary.

Examples of the catalyst include tin-based catalysts such as dibutyltin dilaurate, dioctyltin laurate, and dioctyltin dilaurate, and organophosphate catalysts such as triphenylphosphine. These can be used singly, or can be used in combination of two or more.

The mixing ratio of the catalyst is not particularly limited and is appropriately set depending on the purpose and intended use.

For the reaction conditions in air atmosphere, for example, the reaction temperature is, for example, 40° C. or higher, preferably 60° C. or higher, and for example, 200° C. or lower, preferably 150° C. or lower. Meanwhile, the reaction time is, for example, 1 hour or longer, preferably 2 hours or longer, and for example, 20 hours or shorter, preferably 12 hours or shorter.

In this reaction, a polymerization inhibitor can be added as necessary.

Examples of the polymerization inhibitor include: phenol compounds such as p-methoxyphenol, hydroquinone, hydroquinone monomethyl ether, catechol, tert-butylcatechol, 2,6-di-tert-butyl-hydroxytoluene, 4-tert-butyl-1,2-dihydroxybenzene, and 2,2′-methylene-bis(4-methyl-6-tert-buthylcatechol); aromatic amines such as phenothiazine, diphenyl phenylenediamine, dinaphthyl phenylenediamine, p-aminodiphenylamine, and N-alkyl-N′-Phenylenediamine; N-oxyl derivatives such as 4-hydroxy-2,2,6,6-tetramethylpiperidine, 4-acetoxy-1-oxy-2,2,6,6-tetramethylpiperidine, 4-benzoyloxy-1-oxy-2,2,6,6-tetramethylpiperidine, 4-alkoxy-1-oxy-2,2,6,6-tetramethylpiperidine, bis(-1-oxy-2,2,6,6-tetramethylpiperidine-4-il) sebacate, and 2,2,6,6-tetramethylpiperidine; N-nitrosodiphenylamine; copper salt of diethyldithiocarbamic acid; and p-benzoquinone.

These can be used singly, or can be used in combination of two or more.

For the polymerization inhibitor, preferably, p-methoxyphenol is used.

The mixing ratio of the polymerization inhibitor is, relative to 100 parts by mass of a total amount of the intermediate polymer and active energy ray-curable group-containing compound, for example, 0.0001 parts by mass or more, preferably 0.01 parts by mass or more, and for example, 1.0 part by mass or less, preferably 0.1 parts by mass or less.

In this manner, a part of the thermally reactive group in the intermediate polymer reacts with the corresponding thermally reactive group in the active energy ray-curable group-containing compound and the active energy ray-curable group-containing compound bonds to a side chain of the intermediate polymer. Thus, the active energy ray-curable group (preferably, (meth)acryloyl group) is introduced into the terminal of the side chain.

More specifically, when the intermediate polymer contains an epoxy group as the thermally reactive group and the active energy ray-curable group-containing compound is α,β-unsaturated carboxylic acid, the esterification reaction of the epoxy group with the carboxy group introduces the active energy ray-curable group into the intermediate polymer.

Alternatively, when the intermediate polymer contains a carboxy group as the thermally reactive group and the active energy ray-curable group-containing compound is a hydroxyl group-containing (meth)acrylic compound, the esterification reaction of the carboxy group with the epoxy group introduces the active energy ray-curable group into the intermediate polymer.

Alternatively, when the intermediate polymer contains a hydroxyl group as the thermally reactive group and the active energy ray-curable group-containing compound is an isocyanate group-containing (meth)acrylic compound, the urethanization reaction of the hydroxyl group with the isocyanate group introduces the active energy ray-curable group into the intermediate polymer.

Alternatively, when the intermediate polymer contains an isocyanate group as the thermally reactive group and the active energy ray-curable group-containing compound is a hydroxyl group-containing (meth)acrylic compound, the urethanization reaction of the isocyanate group with the hydroxyl group introduces the active energy ray-curable group into the intermediate polymer.

As a result, the active energy ray-curable resin (active energy ray-curable resin having a layer-side thermally reactive group, a polysiloxane chain, and an active energy ray-curable group) is produced.

That is, the active energy ray-curable resin is a reaction product of the material component (secondary material component) including the polysiloxane-containing compound, thermally reactive group-containing compound, and active energy ray-curable group-containing compound.

In the production of the above-described active energy ray-curable resin, a part of the thermally reactive groups in the intermediate polymer is an introduction group for introducing the active energy ray-curable group into the intermediate polymer side chain. The rest of the thermally reactive group (hereinafter, the remaining thermally reactive group) is a layer-side thermally reactive group for reacting with the mold material (described below).

Alternatively, when the intermediate polymer contains an epoxy group as the introduction group, the ring-opening of the epoxy group generates a hydroxyl group in the reaction of the epoxy group with the active energy ray-curable group-containing compound (for example, α,β-unsaturated carboxylic acid). Such a hydroxyl group is also the layer-side thermally reactive group and contributes to the thermal reaction with the mold material described below.

Alternatively, as necessary, in the introduction of the active energy ray-curable group, the hydroxyl group generated by the ring-opening of the epoxy group can also be used as an introduction group for introducing another active energy ray-curable group.

Relative to a total amount of the non-volatile content in the material component of the active energy ray-curable resin (a total amount of the non-volatile content of the polymerizable component in the intermediate polymer and the active energy ray-curable group-containing compound (the same applies hereinafter)), the content of the polysiloxane-containing compound is, for example, 0.05 mass % or more, preferably 0.10 mass % or more, and for example, 20.0 mass % or less, preferably 10.0 mass % or less.

Meanwhile, relative to a total amount of the non-volatile content in the material component of the active energy ray-curable resin, the content of the thermally reactive group-containing compound is, for example, 30 mass % or more, preferably 50 mass % or more, and for example, 90 mass % or less, preferably 80 mass % or less.

Meanwhile, relative to the total amount of the non-volatile content in the material component of the active energy ray-curable resin, the content of another polymerizable compound is, for example, 10 mass % or more, preferably 20 mass % or more, and for example, 60 mass % or less, preferably 50 mass % or less.

Meanwhile, relative to a total amount of the non-volatile content in the material component of the active energy ray-curable resin, the content of the active energy ray-curable group-containing compound is, for example, 5 mass % or more, preferably 10 mass % or more, and for example, 40 mass % or less, preferably 30 mass % or less.

The ratio of the remaining thermally reactive group, the polysiloxane chain, and the active energy ray-curable group in the active energy ray-curable resin is appropriately set according to the purpose and intended use.

More specifically, for the tight contact with the mold resin, in 1 g of the active energy ray-curable resin, the remaining thermally reactive group is, for example, 0.02 mmol or more, preferably 0.04 mmol or more, and for example, 4.0 mmol or less, preferably 3.0 mmol or less.

Meanwhile, for the interlayer releasability and the uncontaminated condition of the mold, in 1 g of the active energy ray-curable resin, the polysiloxane chain is, for example, 0.00010 mmol or more, preferably 0.0060 mmol or more, and for example, 0.020 mmol or less, preferably 0.010 mmol or less.

Meanwhile, for the abrasion-resistance (described below), in 1 g of the active energy ray-curable resin, the active energy ray-curable group is, for example, 0.10 mmol or more, preferably 0.25 mmol or more, more preferably 0.5 mmol or more, furthermore preferably 1.0 mmol or more, and particularly preferably 1.5 mmol or more. Further, for the tensile elongation, the active energy ray-curable group is, for example, 5.0 mmol or less, preferably 3.5 mmol or less.

Meanwhile, the molar ratio of the remaining thermally reactive group to the polysiloxane chain (remaining thermally reactive group/polysiloxane chain) is, for example, 50 or more, preferably 100 or more, more preferably 150 or more, and for example, 15000 or less, preferably 10000 or less, more preferably 1000 or less, furthermore preferably 400 or less.

Meanwhile, the molar ratio of the remaining thermally reactive group to the active energy ray-curable group (remaining thermally reactive group/active energy ray-curable group) is, for example, 0.1 or more, preferably 0.5 or more, and for example, 3.0 or less, preferably 1.0 or less.

Meanwhile, the molar ratio of the active energy ray-curable group to the polysiloxane chain (active energy ray-curable group/polysiloxane chain) is, for example, 100 or more, preferably 200 or more, and for example, 15000 or less, preferably 10000 or less.

Preferably, the active energy ray-curable resin is produced as a solution and/or dispersion.

In such a case, the solid content (non-volatile content) concentration of the solution and/or dispersion of the active energy ray-curable resin is, for example, 5 mass % or more, preferably 10 mass % or more, and for example, 60 mass % or less, preferably 50 mass % or less.

Further, if necessary, the solvent is added or removed so that the solid content (non-volatile content) concentration of the active energy ray-curable resin can be adjusted in the above-described range, and thus the viscosity of the solvent and/or dispersion of the active energy ray-curable resin can be adjusted.

For example, the viscosity (25° C.) of a 30% mass solution of the active energy ray-curable resin is, for example, 5 mPa s or more, preferably 10 mPa s or more, and for example, 800 mPa s or less, preferably 400 mPa s or less.

Meanwhile, for the abrasion-resistance (described below), the weight-average molecular weight (GPC measurement: in the conversion to polystyrene) of the active energy ray-curable resin is, for example, 2500 or more, preferably 5000 or more, and more preferably 10000 or more. For the tensile elongation, the weight-average molecular weight of the active energy ray-curable resin is, for example, 100000 or less, preferably 50000 or less.

Meanwhile, for the abrasion-resistance (described below), the number-average molecular weight (GPC measurement: in the conversion to polystyrene) of the active energy ray-curable resin is, for example, 1000 or more, preferably 2000 or more, and more preferably 5000 or more. For the tensile elongation, the number-average molecular weight of the active energy ray-curable resin is, for example, 50000 or less, preferably 20000 or less.

For the abrasion-resistance (described below), the glass transition temperature of the active energy ray-curable resin is, for example, 0° C. or more, preferably 5° C. or more. For the tensile elongation, the glass transition temperature of the active energy ray-curable resin is, for example, 70° C. or less, preferably 60° C. or less.

For the abrasion-resistance (described below), the acid value of the active energy ray-curable resin is, for example, 0.1 mgKOH/g or more, preferably 0.5 mgKOH/g or more. For the tensile elongation, the acid value of the active energy ray-curable resin is, for example, 200 mgKOH/g or less, preferably 100 mgKOH/g or less.

Particularly, a higher acid value is preferable for the abrasion-resistance (described below). Specifically, the acid value is preferably 2 mgKOH/g or more, preferably 10 mgKOH/g or more, more preferably 20 mgKOH/g or more, furthermore preferably 40 mgKOH/g or more, particularly preferably 60 mgKOH/g or more.

On the other hand, a lower acid value is preferable for the tensile elongation. Specifically, the acid value is preferably 60 mgKOH/g or less, more preferably 40 mgKOH/g or less, furthermore preferably 20 mgKOH/g or less, particularly preferably 10 mgKOH/g or less.

Furthermore, the hydroxyl value of the active energy ray-curable resin is, for example, 5 mgKOH/g or more, preferably 10 mgKOH/g or more, more preferably 20 mgKOH/g or more, and for example, 90 mgKOH/g or less, preferably 80 mgKOH/g or less.

Particularly, a higher hydroxyl value is preferable for the abrasion-resistance (described below). Specifically, the hydroxyl value is preferably 5 mgKOH/g or more, more preferably 10 mgKOH/g or more, furthermore preferably 20 mgKOH/g or more, furthermore preferably 30 mgKOH/g or more, and particularly preferably 40 mgKOH/g or more.

On the other hand, a lower hydroxyl value is preferable for the tensile elongation. Specifically, the hydroxyl value is preferably 60 mgKOH/g or less, more preferably 50 mgKOH/g or less, furthermore preferably 40 mgKOH/g or less, and particularly preferably 30 mgKOH/g or less.

The epoxy equivalent of the active energy ray-curable resin is, for example, 500 g/eq or more, preferably 1000 g/eq or more, and for example 20000 g/eq or less, preferably 10000 g/eq or less.

Particularly, a higher epoxy equivalent is preferable for the abrasion-resistance (described below). Specifically, the epoxy equivalent is preferably 500 g/eq or more, more preferably 1000 g/eq or more, furthermore preferably 2000 g/eq or more, further more preferably 4000 g/eq or more, and particularly preferably, 10000 g/eq or more.

On the other hand, a lower epoxy equivalent is preferable for the tensile elongation. Specifically, the epoxy equivalent is preferably 10000 g/eq or less, more preferably 5000 g/eq or less, furthermore preferably 3000 g/eq or less, and particularly preferably 2000 g/eq or less.

For the tensile elongation, the (meth)acryloyl equivalent of the active energy ray-curable resin is, for example, 50 g/eq or more, more preferably 100 g/eq or more, furthermore preferably 200 g/eq or more, particularly preferably 300 g/eq or more. For the abrasion-resistance (described below), the (meth)acryloyl equivalent of the active energy ray-curable resin is, for example, 2000 g/eq or less, more preferably 1500 g/eq or less, furthermore preferably 1000 g/eq or less, and particularly preferably 800 g/eq or less.

Then, the active energy ray-curable resin (active energy ray-curable resin having the layer-side thermally reactive group and the polysiloxane chain) produced in this manner can be used for providing the multi-layered sheet 1 that can suppress the contamination of the mold and allows the mold resin 13 (described below) to adhere to the thermally cured layer 14 (described below).

To produce the multi-layered sheet 1, the method is not particularly limited. However, first, a coating agent containing the active energy ray-curable resin is prepared.

The coating agent can contain the active energy ray-curable resin and the above-described solvent at an appropriate ratio.

The coating agent, as necessary, can contain a polymerization initiator.

Examples of the polymerization initiator include photopolymerization initiators such as 2,2-dimethoxy-1,2-diphenylethane-1-on, 1-hydroxycyclohexylphenylketone, 1-cyclohexylphenylketone, 2-hydroxy-2-methyl-1-phenyl-propane-1-on, 1-[4-(2-hydroxyethoxy)-phenyl]-2-hydroxy-2-methyl-1-propane-1-on, 2-methyl-1-[4-(methylthio)phenyl]-2-morpholinopropane-1-on, 2-benzil-2-dimethylamino-1-(4-morpholinophenyl)-butanone-1, bis(2,4,6-trimethylbenzoyl)-phenylphosphine oxide, 2,4,6-trimethylbenzoyl-diphenyl-phosphine oxide, 4-methylbenzophenone, benzophenone, and 2-hydroxy-1-{4-[4-(2-hydroxy-2-methylpropionyl)-benzyl]phenyl}-2-methyl-propane-1-on.

The polymerization initiators may be used singly or in combination of two or more.

The mixing ratio of the polymerization initiator relative to 100 parts by mass of the active energy ray-curable resin is, for example, 0.01 parts by mass or more, preferably 0.5 parts by mass or more, and for example, 10 parts by mass or less, preferably 5 parts by mass or less.

Furthermore, various additives can be added to the coating agent. Examples of the various additives include cross-linking agents, dyes, pigments, drying agents, anticorrosive agents, plasticizers, coating film surface conditioners, antioxidants, ultraviolet absorbers, dispersants, and antistatic agents. The content of the additive is appropriately set in accordance with the purpose and intended use.

The solid content (non-volatile content) concentration of the coating agent is, for example, 10 mass % or more, preferably 20 mass % or more, and for example, 70 mass % or less, preferably 50 mass % or less.

Next, in this method, the produced coating agent is applied and is dried on a surface of the substrate sheet 2.

The method for applying the coating agent on the substrate sheet 2 is not particularly limited. Examples thereof include an application method using a generally available application device such as a roll coater, a bar coater, a doctor blade, a meyer bar, and an air knife and known application methods such as screen printing, offset printing, flexographic printing, brush coating, spray coating, gravure coating, and reverse gravure coating.

The coating agent can be applied on the entire surface of the substrate sheet 2, and can be applied to a part of the surface of the substrate sheet 2. For the application efficiency in application step, the coating agent is preferably applied on the entire surface of the substrate sheet 2.

For the drying conditions, the drying temperature is, for example, 40° C. or more, preferably 60° C. or more, and for example, 180° C. or less, preferably 140° C. or less. The drying time is, for example, 0.5 minutes or more, preferably 1 minute or more, and for example, 60 minutes or less, preferably 30 minutes or less.

The film thickness after the drying is, for example, 50 nm or more, preferably 500 nm or more, and for example, 30 μm or less, preferably 10 μm or less, more preferably 5 μm or less.

Thereafter, in this method, the dried coating film is irradiated with the active energy ray to cure or half-cure the active energy ray-curable resin.

Examples of the active energy ray include ultraviolet rays (UV (the wavelength of 10 nm to 400 nm)) and electron rays.

In the case of curing by the ultraviolet rays, for example, an ultraviolet ray application device having a xenon lamp, a high-pressure mercury lamp, or a metal halide lamp is used as a light source.

The ultraviolet radiation, the light volume of the ultraviolet ray application device, the arrangement of the light source, and the like are appropriately adjusted as needed.

Specifically, when a cured product in C stage is produced by curing the active energy ray-curable resin by UV irradiation in the dried coating film, the accumulated light volume of the UV radiation is, for example, 300 mJ/cm² or more, preferably 500 mJ/cm² or more, and for example 1000 mJ/cm² or less.

Alternatively, when a half-cured product in B stage is produced by curing the active energy ray-curable resin by UV irradiation in the dried coating film, the accumulated light volume of the UV radiation is, for example, 100 mJ/cm² or more, preferably 200 mJ/cm² or more, and for example less than 300 mJ/cm².

By such irradiation of the active energy ray, the active energy ray-curable resin in the dried coating film is cross-linked, thereby forming a three-dimensional structure. This produces the thermally curable layer 3 as a cured product or half-cured product of the active energy ray-curable resin.

The thermally reactive group contained in the active energy ray-curable resin is usually not reacted with the active energy ray, and thus maintains the reactivity after being cured or half-cured by the active energy ray.

In other words, the thermally curable layer 3 contains the active energy ray-curable resin that is cured or half-cured by the active energy ray and simultaneously is not thermally cured yet. Thus, the thermally curable layer 3 is capable of reacting and thermally curing with the mold material described below because of the thermally reactive group.

Furthermore, when a half-cured product in B stage is produced by curing the active energy ray-curable resin as described above, the thermally curable layer 3 contains a free (excess) active energy ray-curable group such as a (meth)acryloyl in addition to the thermally reactive group.

Such a free (excess) active energy ray-curable group functions as a thermally reactive group and is capable of reacting and thermally curing with the mold material as described below. For example, when the mold-side thermally reactive group contains an allyl group, the (meth)acryloyl group functions as the layer-side thermally reactive group.

In other words, examples of the layer-side thermally reactive group include, as described above, a hydroxyl group (hydroxyl group), an epoxy group (glycidyl group), a carboxy group, an isocyanate group, an oxetane group, a primary amino group, and a secondary amino group, and further include a (meth)acryloyl group.

When epoxy resin and/or silicone resin are/is preferably used as the mold resin (described below), a hydroxyl group, an epoxy group, a carboxy group, and a (meth)acryloyl group are preferably used as the corresponding layer-side thermally reactive group.

Alternatively, when polycarbonate resin, polyester resin, and/or acryl resin are/is used, a hydroxyl group, an epoxy group, a carboxy group, an isocyanate group, an oxetane group, a primary amino group, and a secondary amino group are preferably used as the corresponding layer-side thermally reactive group.

The layer-side reactive group may be used singly or in combination of two or more.

Note that, when a (meth)acryloyl group is singly used as the layer-side thermally reactive group, all the thermally reactive groups other than the (meth)acryloyl group (for example, a hydroxyl group (hydroxy group), an epoxy group (glycidyl group), a carboxy group, an isocyanate group, an oxetane group, a primary amino group, and a secondary amino group) in the intermediate polymer can be used as an introduction group for introducing the (meth)acryloyl group.

More specifically, first in the synthesis of the intermediate polymer, the thermally reactive group-containing compound is used at a predetermined ratio, thereby introducing the thermally reactive groups other than the (meth)acryloyl group (for example, a hydroxyl group (hydroxy group), an epoxy group (glycidyl group), a carboxy group, an isocyanate group, an oxetane group, a primary amino group, and a secondary amino group) into the intermediate polymer.

Next, the reaction of the all thermally reactive groups other than the (meth)acryloyl group with the above-described active energy ray-curable group-containing compound introduces the (meth)acryloyl group into the intermediate polymer, thereby producing the active energy ray-curable resin.

Thereafter, the active energy ray-curable resin is irradiated with the active energy ray and semi-cured as described above.

This produces the thermally curable layer 3 by the photo-curing reaction of the part of the (meth)acryloyl groups, and simultaneously keeps the rest of the (meth)acryloyl groups unreacted as the layer-side thermally reactive group.

Further, the rest of the (meth)acryloyl groups as the layer-side thermally reactive groups can be used for self-curing without the reaction with the mold-side thermally reactive groups.

That is, when the mold-side thermally reactive group has an allyl group, the (meth)acryloyl group remaining in the half-cured active energy ray-curable resin works as the layer-side thermally reactive group and reacts with the mold-side thermally reactive group. On the other hand, when the mold-side thermally reactive group does not have an allyl group or when the (meth)acryloyl groups exceed the allyl groups, the (meth)acryloyl groups crosslink themselves, for example, by heating and the half-cured active energy ray-curable resin is further cured.

The thermally curable layer 3 has a thickness of, for example, 10 nm or more, preferably 30 nm or more, more preferably 50 nm or more, furthermore preferably 0.1 μm or more, furthermore preferably 0.2 μm or more, furthermore preferably 0.5 μm or more, furthermore preferably 1.0 μm or more and, for example, 30 μm or less, preferably 20 μm or less, more preferably 10 μm or less, furthermore preferably 5.0 μm or less, furthermore preferably 3.0 μm or less.

Particularly, depending on, for example, the molarity of the active energy ray-curable group, the glass transition temperature of the intermediate polymer, or the weight-average molecular weight of the active energy ray-curable resin, the thickness of the thermally curable layer 3 is adjusted. This allows a thermally cured layer 14 (described below) formed by thermal curing to be a hard coating layer (described below) and thus to protect the surface of a mold resin 13 (described below).

As described above, the thermally curable layer 3 forming the hard coating layer (described below) by thermal curing is a protective layer (thermally-uncured hard coating layer) to protect the surface of the mold resin 13 (described below). Preferably, the thermally curable layer 3 is a protective layer (thermally-uncured hard coating layer).

Although depending on, for example, the molarity of the active energy ray-curable group, the glass transition temperature of the intermediate polymer, or the weight-average molecular weight of the active energy ray-curable resin, for the abrasion-resistance (described below), the thermally curable layer 3 working as the protective layer (thermally-uncured hard coating layer) has a thickness of, for example, 0.2 μm or more, preferably 0.3 μm or more, more preferably 0.4 μm or more, furthermore preferably 0.5 μm or more, furthermore preferably 0.8 μm or more, furthermore preferably 1.0 μm or more and, for example, 30 μm or less, preferably 20 μm or less, more preferably 10 μm or less, furthermore preferably 5.0 μm or less, furthermore preferably 3.0 μm or less.

The total thickness of the multi-layered sheet 1 is, for example, 5 μm or more, preferably 10 μm or more and, for example, 300 μm or less, preferably 100 μm or less.

In the multi-layered sheet 1, the thermally curable layer 3 includes a product of active energy ray-curable resin cured or half-cured by the active energy ray and has the thermally reactive group (layer-side thermally reactive group) capable of reacting and thermally curing with the thermally reactive group (mold-side thermally reactive group) of the mold material (described below), and a polysiloxane chain.

Thus, the multi-layered sheet 1 is disposed in a mold 20 (described below) as described below and the mold material (described below) is injected in the mold 20 (described below), thereby forming the mold resin 13 (described below) as mold resin. Meanwhile, the thermally reactive group of the thermally curable layer 3 reacts and thermally cures with the thermally reactive group of the mold material to adhere therebetween. Further, the thermally curable layer 3 is internally crosslinked (thermally cured), thereby forming the thermally cured layer 14 (described below) from the surface layer of the thermally curable layer 3. This allows the thermally cured layer 14 (described below) to adhere to the mold resin without providing an adhesive layer.

That is, the described-above multi-layered sheet 1 allows the thermally cured layer 14 (described below) of the multi-layered sheet 1 to be in excellently tight contact with the mold resin 13 (described below).

In the described-above multi-layered sheet 1, the thermally curable layer 3 has a polysiloxane chain. Thus, the substrate sheet 2 of the multi-layered sheet 1 is easily peeled from the thermally cured layer 14 (described below) and the mold resin 13 (described below). This suppresses the damage to the mold resin and the member sealed in the mold resin due to the peeling stress.

Furthermore, in the described-above multi-layered sheet 1, the thermally curable layer 3 has a polysiloxane chain. Thus, even when the surface of the thermally curable layer 3 come into contact with the mold 20 (described below), the adherence of the thermally curable layer 3 to the mold 20 (described below) is suppressed. Thus, the contamination of the mold 20 (described below) is suppressed.

Accordingly, the described-above multi-layered sheet 1 is preferably used as a transfer material for producing a surface layer-laminated mold resin.

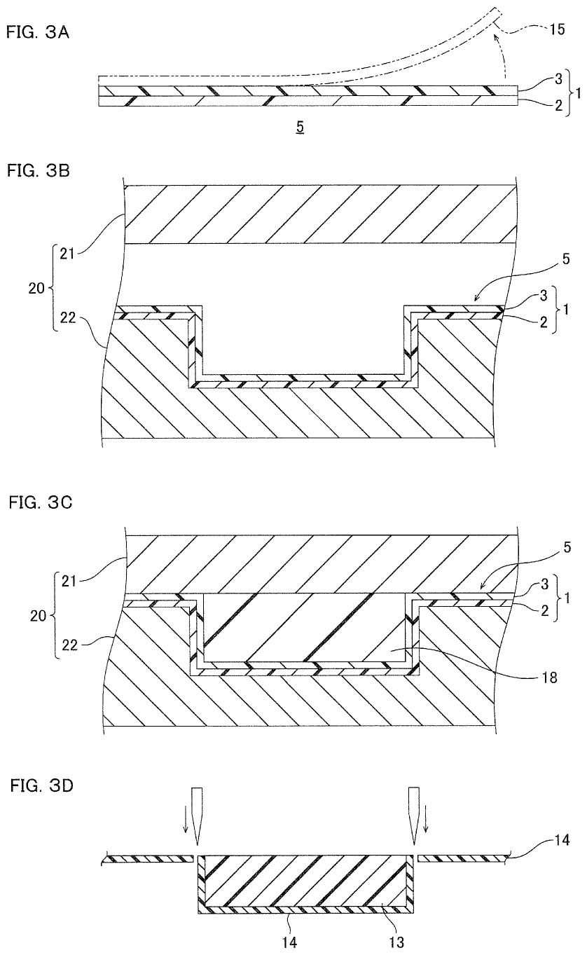

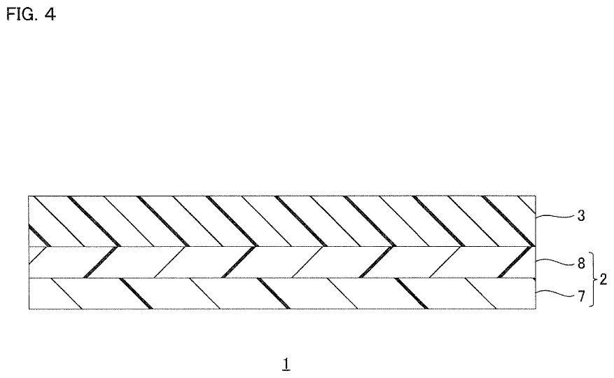

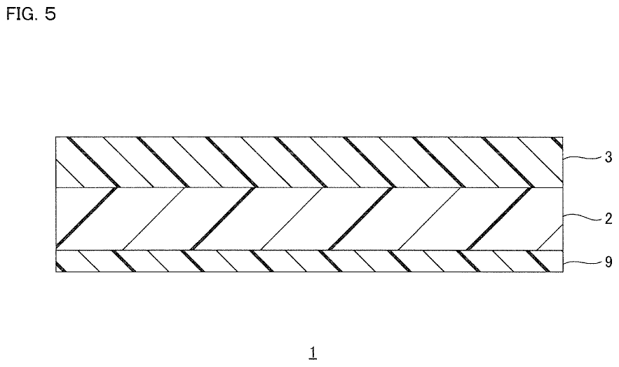

Hereinafter, with reference to FIG. 2 and FIGS. 3A to 3D, a transfer material and a surface layer-laminated mold resin and producing methods thereof will be descried in detail.

In FIG. 2, a surface layer-laminated resin molded article 10 is an embodiment of the surface layer-laminated mold resin.

The laminated resin molded article 10 includes a mold resin 13 and a thermally cured layer 14 working as a surface layer that protects at least a part of the surface (preferably, the entire upper surface and entire side surfaces) of mold resin 13.

The mold resin 13 is resin formed in a mold. A mold material (resin composition) is formed and cured as described below, thereby forming the mold resin 13.

Examples of the mold resin 13 include known resins used for resin molded articles such as epoxy resin, silicone resin, polyester resin, polycarbonate resin, phenol resin, acryl resin, diallyl phthalate resin, and polyurethane resin.

More specifically, for example, the epoxy resin is produced by thermally curing an epoxy resin composition. In such a case, the epoxy resin composition is a mold material and generally contains an epoxy group as the mold-side thermally reactive group.

Similarly, the silicone resin is produced by thermally curing a silicone resin composition. In such a case, the silicone resin composition is a mold material and generally contains an epoxy group, a hydroxyl group, and an allyl group as the mold-side thermally reactive group.

Similarly, the polyester resin is produced by thermally curing a polyester resin composition. In such a case, the polyester resin composition is a mold material and generally contains a hydroxyl group and a carboxy group as the mold-side thermally reactive group.

Similarly, the polycarbonate resin is produced by thermally curing a polycarbonate resin composition. In such a case, the polycarbonate resin composition is a mold material and generally contains a hydroxyl group as the mold-side thermally reactive group.

Similarly, the phenol resin is produced by thermally curing a phenol resin composition. In such a case, the phenol resin composition is a mold material and generally contains a hydroxyl group as the mold-side thermally reactive group.

Similarly, the acryl resin is produced by thermally curing an acryl resin composition. In such a case, the acryl resin composition is a mold material and generally contains a hydroxyl group, a carboxy group, and an epoxy group as the mold-side thermally reactive group.

Similarly, the diallyl phthalate resin is produced by thermally curing a diallyl phthalate resin composition. In such a case, the diallyl phthalate resin composition is a mold material and generally contains an allyl group as the mold-side thermally reactive group.

Similarly, the polyurethane resin is produced by thermally curing a polyurethane resin composition. In such a case, the polyurethane resin composition is a mold material and generally contains an isocyanate group and a hydroxyl group as the mold-side thermal reactive group.

These mold resins 13 may be used singly or in combination of two or more.

For the mold resin 13, preferably, epoxy resin, silicone resin, polycarbonate resin, polyester resin, and acryl resin are used.

The mold resin 13 may be colored or light transmissive as necessary.

The thermally cured layer 14 includes a cured product of active energy ray-curable resin containing a polysiloxane chain.

The thermally cured layer 14 is produced by thermally curing the thermally curable layer 3 of the described-above multi-layered sheet 1. Preferably, the thermally cured layer 14 consists of a cured product produced by thermally curing the thermally curable layer 3.

The thermally cured layer 14 may be colored or light transmissive as necessary.

The thermally cured layer 14 has a thickness of, for example, 10 nm or more, preferably 30 nm or more, more preferably 50 nm or more, furthermore preferably 0.1 μm or more, furthermore preferably 0.2 μm or more, furthermore preferably 0.5 μm or more, furthermore preferably 1.0 μm or more and, for example, 30 μm or less, preferably 20 μm or less, more preferably 10 μm or less, furthermore preferably 5.0 μm or less, furthermore preferably 3.0 μm or less.

The thermally cured layer 14 directly adheres to the mold resin 13 without the mediation of an adhesive layer or the like. Specifically, the thermally cured layer 14 bonds to the mold resin 13 by a chemical bond of the thermally reactive group of the active energy ray-curable resin to the thermally reactive group of the mold material.

To produce the laminated resin molded article 10, for example, as shown in FIG. 3A, first a transfer material 5 including the above-described multi-layered sheet 1 is prepared (Preparation step).

The transfer material 5 includes the above-described multi-layered sheet 1. In other words, the transfer material 5 includes a substrate sheet 2 and the thermally curable layer 3 disposed on a surface of the substrate sheet 2.

Meanwhile, the transfer material 5 does not include an adhesive layer on the uppermost surface and can includes a peelable layer 15 disposed on a surface of the thermally curable layer 3 of the multi-layered sheet 1 as necessary.

That is, the transfer material 5 consists of the multi-layered sheet 1 without an adhesive layer on the uppermost surface. The transfer material 5 can be in form without the peelable layer 15 (namely, form where the thermally curable layer 3 is exposed), or in form including the multi-layered sheet 1 without an adhesive layer on the uppermost surface and including the peelable layer 15 covering the thermally curable layer 3 (namely, form where the thermally curable layer 3 is not exposed).

The peelable layer 15 is a flexible sheet made of resin disposed on a surface of the thermally curable layer 3 as illustrated with the phantom line in FIG. 3A. The peelable layer 15 covers the thermally curable layer 3 and can be peeled while curving from one side toward the other side.

The peelable layer 15 is peeled from the thermally curable layer 3 when the transfer material 5 is used. In the following steps, the transfer material 5 from which the peelable layer 15 is peeled (the rest excluding the peelable layer 15) is used.

Next, in this method as illustrated in FIG. 3B, the transfer material 5 is disposed in a mold 20 so that the thermally curable layer 3 can be exposed (disposition step).

More specifically, in the step, the mold 20 for casting the mold material 18 is prepared first. The mold 20 is a known mold including an upper mold 21 and a lower mold 22 and designed depending on the shape of the laminated resin molded article 10.

Then, in the step, the transfer material 5 is disposed so that the substrate sheet 2 of the transfer material 5 is in tight contact with a concave portion of the lower mold 22. This exposes the thermally curable layer 3 to the inside of the mold.

Next, in the method as illustrated in FIG. 3C, the mold material 18 that is the material component of the mold resin 13 is injected in the mold 20. A layer-side thermally reactive group of the thermally curable layer 3 is reacted and thermally cured with a mold-side thermally reactive group of the mold material 18 (transfer step).

More specifically, in the step, the mold material 18 is first injected into the lower mold 22 on which the transfer material 5 is disposed.

Thereafter, the upper mold 21 is brought into contact with the lower mold 22 to seal the mold material 18 in the mold 20 and the mold 20 is simultaneously heated. This allows the mold material 18 to heat react and produces the mold resin 13 as a resin molded article.

For the heat reaction conditions, the reaction temperature is, for example, 40° C. or more, preferably 60° C. or more and, for example, 200° C. or less, preferably 150° C. or less. Meanwhile, the reaction time is, for example, 1 hour or more, preferably 2 hours or more and, for example, 20 hours or less, preferably 12 hours or less.

This allows the thermally reactive group (layer-side thermally reactive group) of the active energy ray-curable resin contained in the thermally curable layer 3 to heat react with the thermally reactive group (mold-side thermally reactive group) contained in the mold material 18 and bonds them by chemical bonding.

Meanwhile, at the same time, the thermally curable layer 3 is internally crosslinked and a thermally cured layer 14 is produced as a thermally cured product of the thermally curable layer 3.

In other words, in the step, the thermally cured layer 14 is produced as a cured product of the active energy ray-curable resin. At the same time, the thermally cured layer 14 is bound with the mold resin 13 by chemical bonding.

Thereafter, in the method as illustrated in FIG. 3D, the thermally cured layer 14 is peeled from the substrate sheet 2 (peeling step).

Further, as necessary, the excess of the thermally cured layer 14 is cut and removed as illustrated with the arrows in FIG. 3D. This provides the laminated resin molded article 10.

For the method of producing the laminated resin molded article 10, the transfer material 5 including the described-above multi-layered sheet 1 is used.

Thus, when the transfer material 5 including the described-above multi-layered sheet 1 is disposed in the mold 20 and the mold material 18 is injected in the mold 20, the mold resin 13 is formed. At the same time, the thermally reactive group of the thermally curable layer 3 adheres to the thermally reactive group of the mold material 18 by the thermal curing reaction. Further, the thermally curable layer 3 is internally crosslinked (thermally cured) and formed into the thermally cured layer 14. This allows the thermally cured layer 14 to adhere to the mold resin 13 without providing an adhesive layer. Thus, the contamination of the mold is suppressed.

Furthermore, the thermally curable layer 3 has a polysiloxane chain. This gives excellent interlayer releasability between the thermally curable layer 3 and thermally cured layer 14, and the substrate sheet 2, and suppresses the adherence of the surface of the thermally curable layer 3 and thermally cured layer 14 to the lower surface of the upper mold 20 when the surface of the thermally curable layer 3 and thermally cured layer 14 comes in contact with the lower surface of the upper mold 20.

That is, in the method of producing the described-above laminated resin molded article 10, the contamination of the mold 20 is suppressed and the laminated resin molded article 10 with excellently tight contact between the mold resin 13 and the thermally cured layer 14 is efficiently produced.

In the produced laminated resin molded article 10, the contamination of the mold 20 is suppressed and the mold resin adheres to the thermally cured layer 14 without the mediation of an adhesive layer.

More specifically, in a tight contact test (cross-cut test method) in accordance with the Examples described below, the tight contact between the thermally cured layer 14 and the mold resin 13 is, for example, 10/100 or more, preferably 20/100 or more or 30/100 or more, more preferably 40/100 or more, furthermore preferably 50/100 or more, furthermore preferably 60/100 or more, furthermore preferably 70/100 or more, furthermore preferably 80/100 or more, furthermore preferably 90/100 or more, particularly preferably 100/100.

The pencil hardness of the thermally cured layer 14 of the multi-layered sheet 1 (in accordance with the testing method of JIS K5600-5-4 (1999) “Scratch hardness (Pencil method)”) is, for example, 6B or more, preferably 5B or more, more preferably 4B or more, furthermore preferably 3B or more, furthermore preferably 2B or more, furthermore preferably B or more, furthermore preferably HB or more, furthermore preferably F or more, particularly preferably H or more, and generally 10H or less.

Furthermore, in an abrasion-resistance test in accordance with the Examples described below, the turbidity change ΔE is, for example, 10 or less, preferably less than 10, more preferably less than 5, furthermore preferably less than 3, or particularly preferably less than 1.

Accordingly, the multi-layered sheet 1, the transfer material 5, the laminated resin molded article 10, and the producing method thereof are preferably used in various mold resin industries.

When the laminated resin molded article 10 is used in various mold resin industries, for example, the thickness of the thermally cured layer 14 is appropriately adjusted according to the required properties.

More specifically, when the laminated resin molded article 10 is required to have excellent abrasion-resistance (hard coating properties), the thickness of the thermally cured layer 14 is adjusted to a predetermined value or more depending on the properties (such as the molarity of the active energy ray-curable group, the glass transition temperature of the intermediate polymer, and the weight-average molecular weight of the active energy ray-curable resin) of the thermally cured layer 14 to ensure the hard coating properties.

The hard coating properties mean having abrasion-resistance at a predetermined degree or more. More specifically, in an abrasion-resistance test in accordance with the Examples described below, the turbidity change ΔE measured with a haze meter NDH 500 (manufactured by Nippon Denshoku Industries Co., Ltd.) is less than 3.

The thickness of the thermally cured layer 14 as a hard coating layer depends on the molarity of the active energy ray-curable group, the glass transition temperature of the intermediate polymer, or the weight-average molecular weight of the active energy ray-curable resin. However, for the abrasion-resistance, the thickness of the thermally cured layer 14 is, for example, 0.2 μm or more, preferably 0.3 μm or more, more preferably 0.4 μm or more, furthermore preferably 0.5 μm or more, furthermore preferably 0.8 μm or more, furthermore preferably 1.0 μm or more and, for example, 30 μm or less, preferably 20 μm or less, more preferably 10 μm or less, furthermore preferably 5.0 μm or less, furthermore preferably 3.0 μm or less.

Such a laminated resin molded article 10 is preferably used in various industries such as communication equipment, electrical appliances, housing equipment, and automobiles. Further, as necessary, various components such as electronic components may be sealed in the mold resin 13. In the transfer step (FIG. 3C) in such a case, after the mold material 18 is injected, the component to be sealed is embedded in the mold material 18.

In the description, the substrate sheet 2 of the multi-layered sheet 1 is formed of, for example, a plastic film. However, for example, to improve the interlayer releasability, the substrate sheet 2 can include an easily peelable layer 8.

In such a case, as illustrated in FIG. 4, the substrate sheet 2 includes a supporting layer 7, and the easily peelable layer 8 laminated on a surface of the supporting layer 7. Furthermore, the thermally curable layer 3 is laminated on the easily peelable layer 8.

Examples of the supporting layer 7 include the plastic film described above as the substrate sheet 2.

Examples of the easily peelable layer 8 include a surface layer made of water-repellent resin such as fluorine resin, silicone resin, melamine resin, cellulose derivatives resin, urea resin, polyolefin resin, and paraffin resin.

The substrate sheet 2 including the easily peelable layer 8 facilitates easy release of the thermally curable layer 3 (the thermally cured layer 14) from the substrate sheet 2 and improves the production efficiency of the laminated resin molded article 10.

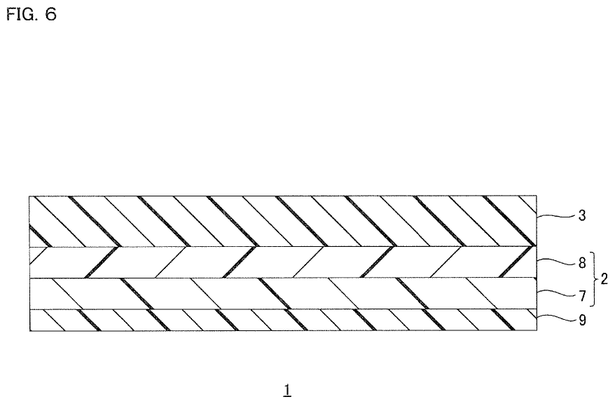

Furthermore, as illustrated in FIG. 5 and FIG. 6, the multi-layered sheet 1 of the present invention can include an anti-mold-adherence layer 9 on the other surface (back surface) of the substrate sheet 2 opposite to the surface on which the above-described thermally curable layer 3 is disposed.

FIG. 5 depicts the form in which the multi-layered sheet 1 of FIG. 1 further includes the anti-mold-adherence layer 9. Similarly, FIG. 6 illustrates the form in which the multi-layered sheet 1 of FIG. 4 further includes the anti-mold-adherence layer 9.

The anti-mold-adherence layer 9 is a layer for preventing the substrate sheet 2 from coming in contact with the mold 20 (especially, the lower mold 22) and, for example, melting and adhering to the mold 20.

The anti-mold-adherence layer 9 is included on the other side surface (hereinafter, the other surface) of the substrate sheet 2 opposite to the surface on which the thermally curable layer 3 is formed.

Examples of the anti-mold-adherence layer 9 are not especially limited and include a coating layer containing water-repellent resin. Examples of the water-repellent resin include silicone resin, melamine resin, cellulose derivatives resin, urea resin, polyolefin resin, and paraffin resin.

Alternatively, examples of the anti-mold-adherence layer 9 also include a cured or half-cured product of the above-described active energy ray-curable resin.

Preferably, the anti-mold-adherence layer 9 includes a cured or half-cured product of the above-described active energy ray-curable resin.

To produce the anti-mold-adherence layer 9, for example, the coating agent (including the active energy ray-curable resin) for forming the described-above thermally curable layer 3 is applied on the other surface of the substrate sheet 2 and dried and then the anti-mold-adherence layer 9 is irradiated with the active energy ray and the described-above active energy ray-curable resin is cured or half-cured.

In this manner, the anti-mold-adherence layer 9 containing the same resin as the described-above thermally curable layer 3 does is produced.

The multi-layered sheet 1 having the anti-mold-adherence layer 9 suppresses the adherence of the substrate sheet 2 to the lower mold 22.

The anti-mold-adherence layer 9 may be formed before the formation of the described-above thermally curable layer 3. Alternatively, the anti-mold-adherence layer 9 may be formed after the formation of the described-above thermally curable layer 3. Alternatively, the anti-mold-adherence layer 9 may be formed at the same time as the formation of the described-above thermally curable layer 3. Preferably, the anti-mold-adherence layer 9 may be formed before the formation of the described-above thermally curable layer 3.

Although not illustrated, as necessary, the multi-layered sheet 1 and the transfer material 5 can include a functional layer such as a design layer, a shield layer, or an embossed layer in addition to the substrate sheet 2 and the thermally curable layer 3.

In such a case, the functional layer is formed on the other surface of the substrate sheet 2 (opposite to the surface on which the thermally curable layer 3 is formed) or between the substrate sheet 2 and the thermally curable layer 3. This formation exposes the thermally curable layer 3 from the uppermost surface of the multi-layered sheet 1. Preferably, the multi-layered sheet 1 consists of the substrate sheet 2 and the thermally curable layer 3.

### EXAMPLES

Next, the present invention will be described based on Examples and Comparative Examples. However, the present invention is not limited to Examples described below. The “parts” and “%” are based on mass unless otherwise specified. The specific numeral values used in the description below, such as mixing ratios (contents), physical property values, and parameters can be replaced with corresponding mixing ratios (contents), physical property values, parameters in the above-described “DESCRIPTION OF EMBODIMENTS”, including the upper limit value (numeral values defined with “or less”, and “less than”) or the lower limit value (numeral values defined with “or more”, and “more than”).

1. Measuring Method

<Weight-Average Molecular Weight and Number-Average Molecular Weight>

0.2 mg of a sample of was taken from the (meth)acrylic resin. The sample was dissolved in 10 mL of tetrahydrofuran to measure the molecular weight distribution of the sample with gel permeation chromatograph (GPC) equipped with a refractive index detector (RID), thereby obtaining chromatogram (chart).

Subsequently, the weight-average molecular weight and number-average molecular weight of the sample was calculated from the obtained chromatogram (chart) with the standard polystyrene as a calibration curve. The measurement device and the measurement conditions are shown below.

Data processing apparatus: product name HLC-8220GPC (manufactured by TOSOH CORPORATION)

Refractive index detector: RI detector built in product name HLC-8220GPC

Column: three pieces of product name “TSKgel GMHXL” (manufactured by TOSOH CORPORATION)

Mobile phase: tetrahydrofuran

Column flow rate: 0.5 mL/min

Injection amount: 20 μL

Measurement temperature: 40° C.

Molecular weight of standard polystyrene: 1250, 3250, 9200, 28500, 68000, 165000, 475000, 950000, 1900000

<Glass Transition Temperature>

The glass transition temperature of the (meth)acrylic resin was determined by the Fox equation.

<Viscosity>

The viscosity was measured in accordance with JIS K5600-2-3 (2014)

<Acid Value>

The acid value was measured in accordance with JIS K5601-2-1 (1999)

<Concentration of Non-Volatile Content>

The concentration of the non-volatile content was measured in accordance with JIS K5601-2-1 (2008)

<Epoxy Equivalent>

The epoxy equivalent was measured in accordance with JIS K7236 (2001)

<Hydroxyl Value>

The hydroxyl value of the (meth)acrylic resin was measured in accordance with JIS K1557-1:2007 (ISO14900: 2001) 4.2B of “Plastics-Polyols for use in the production of polyurethane—Part 1: Determination of hydroxyl number”

The hydroxyl value of the (meth)acrylic resin is the hydroxyl value of the solid content.

<(Meth)Acryloyl Equivalent>

The (meth)acryloyl equivalent of the (meth)acrylic resin was calculated from the monomer composition that is the material for the (meth)acrylic resin in accordance with the following formulation (I).

$$[ Chem 1 ]$$

$$( Meth ) acryloyl equivalent ( g \text{/} eq ) = W \text{/} {\sum }_{i = 1}^{k} ( {M}_{i} \times {N}_{i} ) \qquad ( I )$$

In the formulation (I), “W” is the total usage (g) of the monomers used as the material for the (meth)acrylic resin, “M” is the molarity (mol) of the monomers arbitrarily selected from the monomers used for introducing the (meth)acryloyl group as a side chain to the main chain of the (meth)acrylic resin finally produced in the synthesis of the (meth)acrylic resin, “N” is the number of the (meth)acryloyl groups per one molecule of the arbitrarily selected monomers, and “k” is the number of monomer species used for introducing the (meth)acryloyl group as a side chain to the main chain of the (meth)acrylic resin finally produced in the synthesis of the (meth)acrylic resin.

2. Synthesis of Intermediate Polymer and Active Energy Ray-Curable Resin

### Synthesis Examples 1 to 14

A reaction vessel was charged with 400 parts by weight of methyl isobutyl ketone (MIBK) as a solvent. The solvent was heated to 90° C. and the temperature was maintained.

Glycidyl methacrylate (thermally reactive group-containing compound, GMA), acrylic acid (thermally reactive group-containing compound, AA), 2-hydroxyethyl acrylate (thermally reactive group-containing compound, 2-HEA), FM-0721 (polysiloxane-containing compound, trade name, manufactured by JNC, 3-methacryloxypropyldimethylpolysiloxane), methyl methacrylate (another polymerizable compound, MMA), butyl acrylate (another polymerizable compound, BA), and Azobis-2-methylbutyronitrile (ABN-E) as a radical polymerization initiator were mixed in the amounts shown in Tables 1 to 4, thereby obtaining the polymerizable component.

Subsequently, the polymerizable component was gradually dropped and mixed in the reaction vessel for two hours and was left for two hours. Then, the mixture was heated at 110° C. for two hours for radical polymerization.

In this manner, an intermediate polymer solution was obtained. The intermediate polymer solution was cooled to 60° C.

The glass transition temperature of the obtained intermediate polymer was measured by the above-described method.

Subsequently, with the intermediate polymer solution, acrylic acid (active energy ray-curable group-containing compound, AA), glycidyl methacrylate (active energy ray-curable group-containing compound, GMA), 2-isocyanatoethyl acrylate (active energy ray-curable group-containing compound, AOI), p-methoxyphenol (polymerization inhibitor, MQ), triphenylphosphine (catalyst, TPP), and dibutyltindilaurate (catalyst, DBTDL) were mixed in the amounts shown in Table 1 to 4.

Subsequently, while oxygen was sent in the reaction vessel, the mixture was heated at 110° C. for 8 hours. To the thermally reactive group of the intermediate polymer, acrylic acid (active energy ray-curable group-containing compound, AA), glycidyl methacrylate (active energy ray-curable group-containing compound, GMA), and/or 2-isocyanatoethyl acrylate (active energy ray-curable group-containing compound, AOI) were/was added.

More specifically, a part of the epoxy groups of the intermediate polymer was reacted with the carboxy groups of acryl acid to add an acryloyl group as the active energy ray-curable group to the side chain.

At the same time, the rest of the epoxy groups and the hydroxyl group generated by the ring opening of the epoxy group were kept unreacted (free) as a thermally reactive group.

Meanwhile, a part of the carboxy groups of the intermediate polymer was reacted with the epoxy groups of glycidyl methacrylate to add a methacryloyl group as the active energy ray-curable group to the side chain. At the same time, the rest of the carboxy groups and the hydroxyl group generated by the ring opening of the epoxy group were kept unreacted (free) as a thermally reactive group.

Meanwhile, a part of the hydroxyl groups of the intermediate polymer was reacted with the isocyanate groups of 2-isocyanatoethyl acrylate to add acryloyl groups as the active energy ray-curable groups to the side chain. At the same time, the rest of the hydroxyl groups was kept unreacted (free) as a thermally reactive group.

In this manner, the (meth)acrylic resin was obtained as the active energy ray-curable resin. As necessary, the solvent was added or removed, thereby adjusting the non-volatile content concentration of the active energy ray-curable resin to 30 mass %.

The hydroxyl value, (meth)acryl equivalent, and weight-average molecular weight of the obtained active energy ray-curable resin were measured. The amounts of the thermally reactive groups (remaining thermally reactive group), polysiloxane chains, and active energy ray-curable groups remaining in 1 g of the active energy ray-curable resin were calculated from the charged ratio. The results are shown in Tables 1 to 4.

3. Multi-Layered Sheet and Surface Layer-Laminated Mold Resin

### Examples 1 to 15 and Comparative Examples 1 to 2

Multi-Layered Sheet

Each of the (meth)acrylic resin of Tables 5 to 9 was applied on a surface of a substrate sheet (manufactured by Oji F-Tex Co. Ltd., an olefin film having a thickness of 50 μm) with a bar coater and heated at 60° C. for one minute to remove the solvent.

Thereafter, the (meth)acrylic resin was cured by UV irradiation, thereby forming a layer having a thickness of 1 μm.

In this manner, a multi-layered sheet including a substrate sheet and a layer (thermally curable layer) was produced.

In Examples 1 to 12, and 15, ultraviolet (UV) light with the dominant wavelength of 365 nm was delivered using a high pressure mercury lamp so that the accumulated light volume was 500 mJ/cm². The UV irradiation allowed all the acryloyl groups of the (meth)acrylic resin to react, thereby providing a layer (thermally curable layer) as a fully-cured product.

On the other hand, in Examples 13 and 14, ultraviolet (UV) light with the dominant wavelength of 365 nm was delivered using a high pressure mercury lamp so that the accumulated light volume was 200 mJ/cm². The UV irradiation allowed a part of the acryloyl groups of the (meth)acrylic resin to react, thereby providing a layer (thermally curable layer) as a half-cured product. The rest of the acryloyl groups was kept unreacted.

Formation of Anti-Mold-Adherence Layer

In Example 15, an anti-mold-adherence layer was further formed on the other surface of the substrate sheet opposite to the surface on which the layer was formed.

More specifically, the solution of the (meth)acrylic resin B-3 obtain in Synthesis Example 3 was used as a coating agent for forming an anti-mold-adherence layer. The solution was applied on the other surface of the substrate sheet (manufactured by Oji F-Tex Co. Ltd., an olefin film having a thickness of 50 μm) with a bar coater and heated at 60° C. for one minute to remove the solvent.

Thereafter, ultraviolet (UV) light with the dominant wavelength of 365 nm was delivered with a high pressure mercury lamp so that the accumulated light volume was 500 mJ/cm2, thereby curing the (meth)acrylic resin B-3 and forming an anti-mold-adherence layer with a film thickness of 1 μm.

Surface Layer-Laminated Mold Resin

A casting mold formed of a set of an upper mold and a lower mold was prepared. The multi-layered sheet was set on the lower mold so that the protective layer faces the inside of the mold. For making accurate evaluations in accordance with JIS K 5600-5-6 (1999) of the tight contact of the surface layer-laminated mold resin formed by the mold, a mold having a flat and smooth surface was used as the lower mold.

Thereafter, in Examples 1 to 13, and 15, an epoxy resin composition (manufactured by Marumoto Struers K.K. epoxy resin trade name EPOFIX) as the mold material was injected and filled in the mold. The upper mold was set thereon. And curing was carried out at 100° C. for one hour. In this manner, the mold resin (epoxy resin molded article) was produced while the mold resin was connected to the multi-layered sheet by thermal curing reaction.

In Example 13, the heating allowed the remaining acryloyl groups to be self-crosslinked, thereby further curing the layer.

In Example 14, except that diallyl phthalate resin composition (manufactured by OSAKA SODA CO., LTD. diallyl phthalate resin trade name: DAISO DAP A) was used as the mold material, the mold resin was connected to the multi-layered sheet by thermal curing reaction in the same manner as in Examples 1 to 13, and 15.

Thereafter, the mold resin (molded article) was removed from the mold. At the same time, the substrate sheet was peeled from the surface layer (thermally cured layer), thereby producing the surface layer (thermally cured layer)-laminated mold resin.

### Comparative Example 3

The (meth)acrylic resin of Table 8 was applied to a surface of the substrate sheet (manufactured by Oji F-Tex Co. Ltd., an olefin film having a thickness of 50 μm) with a bar coater and heated at 60° C. for one minute to remove the solvent.

Thereafter, the (meth)acrylic resin was cured by UV irradiation, thereby forming a layer having a film thickness of 1 μm.

Thereafter, HARIACRON 350B (trade name, acryl pressure sensitive adhesive composition, manufactured by Harima Chemicals Group, Inc.) was applied to a surface of the layer with a bar coater and heated at 60° C. for one minute, thereby forming an adhesive layer having a film thickness of 1 μm.

In this manner, a multi-layered sheet including the substrate sheet, the layer (thermally curable layer), and the adhesive layer was produced.

In the same manner as Example 1, a surface layer-laminated mold resin with a (thermally cured layer) was produced.

### Comparative Example 4

To evaluate the properties of the mold resin, the mold resin was laminated on a substrate sheet.

That is, an epoxy resin composition (manufactured by Marumoto Struers K.K. epoxy resin trade name EPOFIX) was applied as the mold material on a surface of the substrate sheet (manufactured by Oji F-Tex Co. Ltd., an olefin film having a thickness of 50 μm) with a bar coater. Then, the solvent was removed by drying.

In this manner, a mold material layer (thermally-uncured epoxy resin layer) having a film thickness of 1 μm was formed on the substrate sheet, thereby producing a multi-layered sheet.

Subsequently, a casting mold formed of a set of an upper mold and a lower mold was prepared. The multi-layered sheet was set on the lower mold so that the mold material layer faces the inside of the mold. For making accurate evaluations in accordance with JIS K 5600-5-6 (1999) of the tight contact of the surface layer-laminated mold resin formed by the mold, a mold having a flat and smooth surface was used as the lower mold.

Thereafter, an epoxy resin composition (manufactured by Marumoto Struers K.K. epoxy resin trade name EPOFIX) was injected and filled as the mold material in the mold. The upper mold was set thereon. And curing was carried out at 100° C. for one hour.

In this manner, the mold resin (epoxy resin molded article) was produced. At the same time, the mold resin layer (thermally cured epoxy resin layer) was formed by the thermal curing of the mold material layer. In this manner, the mold resin as a molded resin was connected to the mold resin layer (thermally cured epoxy resin layer) of the multi-layered sheet by the thermal curing reaction.

Thereafter, the mold resin (molded article) was removed from the mold while the substrate sheet was peeled from the mold resin layer, thereby producing the mold resin with the mold resin layer.

### Example 16

Multi-Layered Sheet

The (meth)acrylic resin of Table 9 was applied on a surface of the substrate sheet (manufactured by Oji F-Tex Co. Ltd., an olefin film having a thickness of 50 μm) with a bar coater and heated at 60° C. for one minute to remove the solvent.

Thereafter, ultraviolet (UV) light with the dominant wavelength of 365 nm and the accumulated light volume of 500 mJ/cm² was delivered from a high pressure mercury lamp, thereby forming a layer (thermally curable layer) having a film thickness of 1 μm. In this manner, a multi-layered sheet including the substrate sheet and the layer (thermally curable layer) was produced.

Surface Layer-Laminated Mold Resin

A casting mold formed of a set of an upper mold and a lower mold was prepared. The multi-layered sheet was set on the lower mold so that the protective layer faces the inside of the mold. For making accurate evaluations of the tight contact of the surface layer-laminated mold resin formed by the mold in accordance with JIS K5600-5-6 (1999), a mold having a flat and smooth surface was used as the lower mold.

Thereafter, an epoxy resin composition (manufactured by Marumoto Struers K.K. epoxy resin trade name EPOFIX) was injected and filled as the mold material in the mold. The upper mold was set thereon. And curing was carried out at 100° C. for one hour. In this manner, the mold resin (epoxy resin molded article) was produced while the mold resin was connected to the layer (thermally cured epoxy resin layer) of the multi-layered sheet by the thermal curing reaction.

Thereafter, the mold resin (molded article) was removed from the mold while the substrate sheet was peeled from the surface layer, thereby producing the surface layer-laminated mold resin.

### Comparative Example 5

Except that a substrate sheet (manufactured by Oji F-Tex Co. Ltd., an olefin film having a thickness of 50 μm) was used in place of the multi-layered sheet, a mold resin was produced in the same method as Example 1.

4. Evaluations

(1) Tensile Elongation

The tensile elongation of the multi-layered sheet was measured in accordance with Plastics-Determination of tensile properties (JIS K7127 (1999)). In Comparative Example 5, the tensile elongation of the substrate sheet was measured instead of that of the multi-layered sheet.

Specifically, using a test piece having a thickness of 30 μm, a width of 25 mm, and a length of 115 mm, the tensile elongation (%) until the test piece was broken was measured under the conditions of a tensile speed 100 mm/minute, a distance between the chucks of 80 mm, a gauge distance of 25 mm, and a temperature of 23° C.

The evaluation standard will be described below.

A: the tensile elongation 10% or more

B: the tensile elongation 5% or more and less than 10%

C: the tensile elongation less than 5%

(2) Pencil Hardness

The pencil hardness of the surface layer (thermally cured layer) was evaluated in accordance with the testing method of JIS K5600-5-4 (1999) “Scratch hardness (Pencil method)”. In Comparative Example 4, the pencil hardness of the mold resin layer (thermally cured epoxy resin layer) was evaluated instead of the surface layer (thermally cured layer). In Comparative Example 5, the pencil hardness of the mold resin without a surface layer was evaluated instead of the surface layer (thermally cured layer).

The evaluation standard was B, HB, F, and H in ascending order of hardness. The larger the number followed by “H” is, the higher the hardness is. The larger the number followed by “B” is, the lower the hardness is.

(3) Tight Contact (Adhesion)

The tight contact of the surface layer (thermally cured layer) with the mold resin was evaluated in accordance with the testing method “Cross-cut test” of JIS K5600-5-6 (1999).

Specifically, the surface layer (thermally cured layer) of the described-above surface layer-laminated mold resin was vertically and horizontally cut into 100 cut pieces with a cutter knife so that the cross-cuts penetrated to the mold resin.

A pressure sensitive adhesive tape (manufactured by NICHIBAN “Nichiban tape No. 1” was applied on the cross-cuts. The applied tape was removed. Thereafter, the number of the remaining cross-cuts without being peeled off was counted.

In Comparative Example 4, the tight contact of the mold resin layer (thermally cured epoxy resin layer) with the mold resin (molded resin) was evaluated.

(4) Abrasion-Resistance

In place of the surface layer-laminated mold resin, a test plate with the surface layer (thermally cured layer) was prepared. That is, the (meth)acrylic resin was applied on the surface of the test plate (acryl plate) and photo-cured under the conditions of Examples and Comparative Examples 1 to 3. Thereafter, thermal curing was carried out under the same conditions as those for forming the mold resin. In this manner, a surface layer (thermally cured layer) was formed on the surface of the test plate (acryl plate).

For the evaluations of Comparative Example 4 and Comparative Example 5, the mold material (epoxy resin composition) was applied on the surface of the test plate (acryl plate). And thermal curing was carried out. In this manner, the mold resin layer (epoxy resin layer) was formed on the surface of the test plate (acryl plate).

Thereafter, steel wool (manufactured by BONSTAR SALES Co., Ltd. product number #0000) horizontally reciprocated 10 times on the surface of the surface layer (thermally cured layer) and mold resin layer (thermally cured epoxy resin layer). The load was 100 g per 1 cm².

Thereafter, the haze (turbidity) of the surface layer (thermally cured layer) and mold resin layer (thermally cured epoxy resin layer) was measured with a haze meter NDH 5000 (manufactured by Nippon Denshoku Industries Co., Ltd.) before and after the friction of the steel wool, thereby calculating the color difference ΔE.

The evaluation criteria will be described below.

A: ΔE was 0 or more or less than 1

B: ΔE was 1 or more or less than 3

C: ΔE was 3 or more or less than 10

(5) Mold Contamination

When the surface layer-laminated mold resin was formed, an amount of the contact layer that was in contact with the upper mold and was transferred (adhered) to the upper mold was observed and evaluated.

More specifically, in Examples and Comparative Examples 1 to 3, the transfer (adherence) of the surface layer (thermally cured layer) to the upper mold was observed and evaluated.

In Comparative Example 4, in the same manner as the above, the transfer (adherence) of the mold resin layer (thermally cured epoxy resin layer) to the upper mold was observed and evaluated.

In Comparative Example 5, in the same manner as the above, the transfer (adherence) of the substrate sheet to the upper mold was observed and evaluated.

The evaluation criteria will be described below. Hereinafter, a contact layer is a layer in contact with the upper mold at the mold forming. In Examples and Comparative Examples 1 to 3, the contact layer is the surface layer (thermally cured layer). In Comparative Example 4, the contact layer is the mold resin layer (thermally cured epoxy resin layer). In Comparative Example 5, the contact layer is the substrate sheet.

A: The contact layer was not transferred to the upper mold (transferred area ratio 0%)

B: More than 0% and 10% or less of the area of the coating in the contact layer was transferred to the upper mold.

C: More than 10% of the area of the coating in the contact layer was transferred to the upper mold.

(6) Releasability (Stress Suppression)

The stress (peel force) when the substrate sheet was peeled from the surface layer-laminated mold resin was measured.

More specifically, each of the multi-layered sheets of Examples and Comparative Examples was heated at 100° C. for one hour to cure the surface layer of the multi-layered sheet. Then, the peel force for peeling the substrate sheet from the cured surface layer was measured by a Peeling Tester TE-1003 (manufactured by TESTER SANGYO CO., LTD.). In this manner, the interlayer releasability was evaluated.

In Comparative Example 4, in the same manner as the above, the peel force for peeling the substrate sheet from the mold resin layer was measured. In this manner, the interlayer releasability was evaluated.

In Comparative Example 5, the peel force for peeling the substrate sheet from the mold resin was measured. In this manner, the stress (releasability) on the mold resin when the substrate sheet was peeled.

The evaluation standard will be described below.

A: Peel Force less than 0.1 N/25 mm

B: Peel Force 0.1 N/25 mm or more and less than 0.3 N/25 mm

C: Peel Force 0.3 N/25 mm or more

TABLE 1

| | | | Synthesis | Synthesis | Synthesis | Synthesis |
|---|---|---|---|---|---|---|
| No. | | | Example 1 | Example 2 | Example 3 | Example 4 |
| Intermediate polymer | | | A-1 | | | |
| Formulation | Thermally reactive | GMA | 70 | | | |
| (part(s) by mass) | group-containing | AA | — | | | |
| | compound | 2-HEA | — | | | |
| | Polysiloxane- | FM-0721 | 5 | | | |
| | containing compound | | | | | |
| | Other polymerizable | MMA | 10 | | | |
| | compounds | BA | 15 | | | |
| | Monomers in total | | 100 | | | |
| | Catalyst | ABN-E | 2 | | | |
| | Solvent | MIBK | 233 | | | |
| Evaluation | | Mw (Weight-average molecular weight) | 20000 | | | |
| | | Mn (Number-average molecular weight) | 10000 | | | |
| | | Tg (Glass transition temperature) | 26° C. | | | |
| | | Viscosity (mPa · s/25° C.) | 22 | | | |
| | | Acid value (mgKOH/g) | 0.1 | | | |
| | | Non-volatile content (mass %) | 30% | | | |
| | | Hydroxyl value (mgKOH/g) | — | | | |
| | | Epoxy equivalent (g/eq) | 680 | | | |
| Active energy ray-curable resin | | | B-1 | B-2 | B-3 | B-4 |
| Formulation | Intermediate polymer | Type | A-1 | A-1 | A-1 | A-1 |
| (part(s) by mass) | | Solution amount (30%) | 76 | 80 | 85 | 90 |
| | Active energy ray- | AA | 7 | 6 | 5 | 3 |
| | curable group- | GMA | — | — | — | — |
| | containing compound | Karenz AOI | — | — | — | — |
| | Solvent | MIBK | 17 | 14 | 10 | 7 |
| | Total | | 100 | 100 | 100 | 100 |
| | Catalyst | Triphenylphosphine | 0.1 | 0.1 | 0.1 | 0.1 |
| | | Dibutyltin dilaurate | — | — | — | — |
| | Polymerization | p-Methoxyphenol | 0.05 | 0.05 | 0.05 | 0.05 |
| | inhibitor | | | | | |

| Ratio of polysiloxane-conta.ning compound relative to total amount of | | 3.8 | 4.0 | 4.3 | 4.5 |
|---|---|---|---|---|---|
| material (non-volatile content) of active energy ray-curable resin | | | | | |
| Thermally reactive group (moles) in active energy ray-curable group- | | 90 | 70 | 50 | 30 |
| containing compound relative to 100 moles of thermally reactive | | | | | |
| group in intermediate polymer | | | | | |
| Number of functional | Remaining thermally reactive group | 0.51 | 1.17 | 1.88 | 3.05 |
| groups (mmol/g) per 1 g | Polysiloxane chain | 0.0076 | 0.0080 | 0.0085 | 0.0090 |
| of active energy ray- | Active energy ray-curable group | 3.24 | 2.78 | 2.31 | 1.39 |
| curable resin | | | | | |
| Evaluation | Mw (Weight-average molecular weight) | 21000 | 22000 | 22000 | 21000 |
| | Mn (Number-average molecular weight) | 12000 | 12000 | 12000 | 11000 |
| | Viscosity (mPa · s/25° C.) | 18 | 17 | 17 | 20 |
| | Non-volatile content (mass %) | 30% | 30% | 30% | 30% |
| | Acid value (mgKOH/g) | 0.6 | 0.5 | 0.4 | 0.6 |
| | Hydroxyl value (mgKOH/g) | 60 | 45 | 35 | 20 |
| | Epoxy equivalent (g/eq) | 8500 | 3500 | 2200 | 1100 |
| | (Meth)acryloyl equivalent (g/eq) | 300 | 360 | 480 | 750 |

TABLE 2

| | | | Synthesis | Synthesis | Synthesis | Synthesis |
|---|---|---|---|---|---|---|
| No. | | | Example 5 | Example 6 | Example 7 | Example 8 |
| Intermediate polymer | | | A-2 | A-3 | A-4 | A-5 |
| Formulation (part(s) by mass) | Thermally reactive | GMA | 50 | 50 | 70 | 70 |
| | group-containing | AA | — | — | — | — |
| | compound | 2-HEA | — | — | — | — |
| | Polysiloxane- | FM-0721 | 5 | 5 | 5 | 5 |
| | containing compound | | | | | |
| | Other polymerizable | MMA | 44 | 10 | 10 | 10 |
| | compounds | BA | 1 | 35 | 15 | 15 |
| | Monomers in total | | 100 | 100 | 100 | 100 |
| | Catalyst | ABN-E | 2 | 2 | 0.5 | 4 |
| | Solvent | MIBK | 233 | 233 | 233 | 233 |
| Evaluation | | Mw (Weight-average molecular weight) | 18000 | 22000 | 80000 | 6000 |
| | | Mn (Number-average molecular weight) | 9500 | 9500 | 34000 | 3500 |
| | | Tg (Glass transition temperature) | 63° C. | 2° C. | 26° C. | 26° C. |
| | | Viscosity (mPa · s/25° C.) | 20 | 23 | 450 | 8 |
| | | Acid value (mgKOH/g) | 0.2 | 0.1 | 0.2 | 0.2 |
| | | Non-volatile content (mass %) | 30% | 30% | 30% | 30% |
| | | Hydroxyl value (mgKOH/g) | — | — | — | — |
| | | Epoxy equivalent (g/eq) | 880 | 880 | 680 | 680 |
| Active energy ray-curable resin | | | B-5 | B-6 | B-7 | B-8 |
| Formulation (part(s) by mass) | Intermediate polymer | Type | A-2 | A-3 | A-4 | A-5 |
| | | Solution amount (30%) | 86 | 86 | 85 | 85 |
| | Active energy ray- | AA | 3 | 3 | 5 | 5 |
| | curable group- | GMA | — | — | — | — |
| | containing compound | Karenz AOI | — | — | — | 0 |
| | Solvent | MIBK | 11 | 11 | 10 | 10 |
| | Total | | 100 | 100 | 100 | 100 |
| | Catalyst | Triphenylphosphine | 0.1 | 0.1 | 0.1 | 0.1 |
| | | Dibutyltin dilaurate | — | — | — | — |
| | Polymerization | p-Methoxyphenol | 0.05 | 0.05 | 0.05 | 0.05 |
| | inhibitor | | | | | |

| Ratio of polysiloxane-containing compound relative to total amount of | | 4.3 | 4.3 | 4.25 | 4.25 |
|---|---|---|---|---|---|
| material (non-volatile content) of active energy ray-curable resin | | | | | |
| Thermally reactive group (moles) in active energy ray-curable group- | | 50 | 50 | 50 | 50 |
| containing compound relative to 100 moles of thermally reactive group | | | | | |
| in intermediate polymer | | | | | |
| Number of functional groups | Remaining thermally reactive group | 1.64 | 1.64 | 1.88 | 1.88 |
| (mmol/g) per 1 g of active | Polysiloxane chain | 0.0086 | 0.0086 | 0.0085 | 0.0085 |
| energy ray-curable resin | Active energy ray-curable group | 1.39 | 1.39 | 2.31 | 2.31 |
| Evaluation | Mw (Weight-average molecular weight) | 20000 | 20000 | 85000 | 7000 |
| | Mn (Number-average molecular weight) | 10000 | 11000 | 38000 | 4000 |
| | Viscosity (mPa · s/25° C.) | 18 | 20 | 550 | 12 |
| | Non-volatile content (mass %) | 30% | 30% | 30% | 30% |
| | Acid value (mgKOH/g) | 0.5 | 0.4 | 0.6 | 0.5 |
| | Hydroxyl value (mgKOH/g) | 20 | 20 | 35 | 35 |
| | Epoxy equivalent (g/eq) | 1300 | 1300 | 2200 | 2200 |
| | (Meth)acryloyl equivalent (g/eq) | 640 | 640 | 480 | 480 |

TABLE 3

| | | | Synthesis | Synthesis | Synthesis | Synthesis |
|---|---|---|---|---|---|---|
| No. | | | Example 9 | Example 10 | Example 11 | Example 12 |
| Intermediate polymer | | | A-6 | A-7 | A-8 | A-9 |
| Formulation (part(s) by mass) | Thermally reactive | GMA | 70 | 70 | — | — |
| | group-containing | AA | — | — | 50 | — |
| | compound | 2-HEA | — | — | — | 30 |
| | Polysiloxane- | FM-0721 | 10 | 0.1 | 5 | 5 |
| | containing compound | | | | | |
| | Other polymerizable | MMA | 10 | 10 | 15 | 50 |
| | compounds | BA | 10 | 19.9 | 30 | 15 |
| | Monomers in total | | 100 | 100 | 100 | 100 |
| | Catalyst | ABN-E | 2 | 2 | 2 | 2 |
| | Solvent | MIBK | 233 | 233 | 233 | 233 |
| Evaluation | | Mw (Weight-average molecular weight) | 19000 | 23000 | 26000 | 24000 |
| | | Mn (Number-average molecular | 11000 | 8500 | 9000 | 8000 |
| | | weight) | | | | |
| | | Tg (Glass transition temperature) | 29° C. | 22° C. | 32° C. | 25° C. |
| | | Viscosity (mPa · s/25° C.) | 21 | 24 | 23 | 18 |
| | | Acid value (mgKOH/g) | 0.1 | 0.1 | 120 | 0.1 |
| | | Non-volatile content (mass %) | 30% | 30% | 30% | 30% |
| | | Hydroxyl value (mgKOH/g) | — | — | — | 44 |
| | | Epoxy equivalent (g/eq) | 680 | 680 | — | — |
| Active energy ray-curable resin | | | B-9 | B-10 | B-11 | B-12 |
| Formulation (part(s) by mass) | Intermediate polymer | Type | A-6 | A-7 | A-8 | A-9 |
| | | Solution amount (30%) | 85 | 85 | 67 | 85 |
| | Active energy ray- | AA | 5 | 5 | — | — |
| | curable group- | GMA | — | — | 10 | — |
| | containing compound | Karenz AOI | — | — | — | 5 |
| | Solvent | MIBK | 10 | 10 | 23 | 10 |
| | Total | | 100 | 100 | 100 | 100 |
| | Catalyst | Triphenylphosphine | 0.1 | 0.1 | 0.1 | — |
| | | Dibutyltin dilaurate | — | — | — | 0.1 |
| | Polymerization | p-Methoxyphenol | 0.05 | 0.05 | 0.05 | 0.05 |
| | inhibitor | | | | | |

| Ratio of polysiloxane-containing compound relative to total amount of | | 8.5 | 0.085 | 3.35 | 4.25 |
|---|---|---|---|---|---|
| material (non-volatile content) of active energy ray-curable resin | | | | | |
| Thermally reactive group (moles) in active energy ray-curable group- | | 50 | 50 | 50 | 50 |
| containing compound relative to 100 moles of thermally reactive group | | | | | |
| in intermediate polymer | | | | | |
| Number of functional | Remaining thermally reactive group | 1.88 | 1.88 | 2.31 | 1.02 |
| groups (mmol/g) per 1 g of | Polysiloxane chain | 0.017 | 0.00017 | 0.0067 | 0.0085 |
| active energy ray-curable | Active energy ray-curable group | 2.31 | 2.31 | 2.35 | 1.18 |
| resin | | | | | |
| Evaluation | Mw (Weight-average molecular weight) | 21000 | 22000 | 17000 | 26000 |
| | Mn (Number-average molecular | 12000 | 11000 | 9000 | 11000 |
| | weight) | | | | |
| | Viscosity (mPa · s/25° C.) | 19 | 18 | 20 | 21 |
| | Non-volatile content (mass %) | 30% | 30% | 30% | 30% |
| | Acid value (mgKOH/g) | 0.5 | 0.5 | 60 | 0.2 |
| | Hydroxyl value (mgKOH/g) | 35 | 35 | 35 | 20 |
| | Epoxy equivalent (g/eq) | 2200 | 2200 | — | — |
| | (Meth)acryloyl equivalent (g/eq) | 480 | 480 | 430 | 900 |

TABLE 4

| | | | Synthesis | Synthesis |
|---|---|---|---|---|
| | | | Example | Example |
| No. | | | 13 | 14 |
| Intermediate polymer | | | A-10 | A-11 |
| Formulation (part(s) by mass) | Thermally reactive | GMA | 70 | — |
| | group-containing | AA | — | — |
| | compound | 2-HEA | — | — |
| | Polysiloxane- | FM-0721 | — | 5 |
| | containing compound | | | |
| | Other polymerizable | MMA | 10 | 65 |
| | compounds | BA | 20 | 30 |
| | Monomers in total | | 100 | 100 |
| | Catalyst | ABN-E | 2 | 2 |
| | Solvent | MIBK | 233 | 233 |
| Evaluation | | Mw (Weight-average molecular weight) | 19000 | 23000 |
| | | Mn (Number-average molecular weight) | 9000 | 11000 |
| | | Tg (Glass transition temperature) | 20° C. | 33° C. |
| | | Viscosity (mPa · s/25° C.) | 21 | 25 |
| | | Acid value (mgKOH/g) | 0.1 | 0.1 |
| | | Non-volatile content (mass %) | 30% | 30% |
| | | Hydroxyl value (mgKOH/g) | — | — |
| | | Epoxy equivalent (g/eq) | 680 | — |
| Active energy ray-curable resin | | | B-13 | B-14 |
| Formulation (part(s) by mass) | Intermediate polymer | Type | A-10 | A-11 |
| | | Solution amount (30%) | 85 | 100 |
| | Active energy ray- | AA | 5 | — |
| | curable group- | GMA | — | — |
| | containing compound | Karenz AOI | — | — |
| | Solvent | MIBK | 10 | — |
| | Total | | 100 | 100 |
| | Catalyst | Triphenylphosphine | 0.1 | — |
| | | Dibutyltin dilaurate | — | — |
| | Polymerization inhibitor | p-Methoxyphenol | 0.05 | — |

| Ratio of polysiloxane-containing compound relative to total amount of | | — | — |
|---|---|---|---|
| material (non-volatile content) of active energy ray-curable resin | | | |
| Thermally reactive group (moles) in active energy ray-curable group- | | 50 | — |
| containing compound relative to 100 moles of thermally reactive group in | | | |
| intermediate polymer | | | |
| Number of functional groups | Remaining thermally reactive group | 1.88 | — |
| (mmol/g) per 1 g of active | Polysiloxane chain | 0 | — |
| energy ray-curable resin | Active energy ray-curable group | 2.31 | — |
| Evaluation | Mw (Weight-average molecular weight) | 22000 | 23000 |
| | Mn (Number-average molecular weight) | 8000 | 11000 |
| | Viscosity (mPa · s/25° C.) | 20 | 25 |
| | Non-volatile content (mass %) | 30% | 30% |
| | Acid value (mgKOH/g) | 0.5 | 0.1 |
| | Hydroxyl value (mgKOH/g) | 35 | — |
| | Epoxy equivalent (g/eq) | 2200 | — |
| | (Meth)acryloyl equivalent (g/eq) | 480 | — |

TABLE 5

| | | | Example | Example | Example | Example |
|---|---|---|---|---|---|---|
| No. | | | 1 | 2 | 3 | 4 |
| Multi-layered sheet-Surface layer-laminated mold resin | | | C-1 | C-2 | C-3 | C-4 |
| Formulation (part(s) by mass) | Active energy ray- | Type | B-1 | B-2 | B-3 | B-4 |
| | curable resin | Solid content | 100 | 100 | 100 | 100 |
| | Polymerization initiator | IRGACURE 127 | 0.8 | 0.8 | 0.8 | 0.8 |

| | | | | |
|---|---|---|---|---|
| Total | 100.8 | 100.8 | 100.8 | 100.8 |

| Polysiloxane group | | Present | Present | Present | Present |
|---|---|---|---|---|---|
| Thermally reactive group | Hydroxyl group | Present | Present | Present | Present |
| | Epoxy group (glycidyl group) | Present | Present | Present | Present |
| | Carboxy group | — | — | — | — |
| | (Meth)acryloyl group | — | — | — | — |
| Thickness of layer (μm) | | 1 | 1 | 1 | 1 |
| Adhesive layer | | Absent | Absent | Absent | Absent |
| Anti-mold-adherence layer | | Absent | Absent | Absent | Absent |
| Accumulated light volume of radiation (ML/cm²) | | 500 | 500 | 500 | 500 |
| Evaluation | Tensile elongation (%) | B | B | A | A |
| | Pencil hardness | H | H | H | H |
| | Tight contact | 100/100 | 100/100 | 100/100 | 100/100 |
| | Abrasion-resistance (ΔE) | A | A | A | B |
| | Mold contamination (transfer) | A | A | A | A |
| | Releasability (stress suppression) | A | A | A | A |

TABLE 6

| | | | Example | Example | Example | Example |
|---|---|---|---|---|---|---|
| No. | | | 5 | 6 | 7 | 8 |
| Multi-layered sheet-Surface layer-laminated mold resin | | | C-5 | C-6 | C-7 | C-8 |
| Formulation (part(s) by mass) | Active energy ray-curable resin | Type | B-5 | B-6 | B-7 | B-8 |
| | | Solid content | 100 | 100 | 100 | 100 |
| | Polymerization initiator | IRGACURE 127 | 0.8 | 0.8 | 0.8 | 0.8 |

| | | | | |
|---|---|---|---|---|
| Total | 100.8 | 100.8 | 100.8 | 100.8 |

| Polysiloxane group | | Present | Present | Present | Present |
|---|---|---|---|---|---|
| Thermally reactive group | Hydroxyl group | Present | Present | Present | Present |
| | Epoxy group (glycidyl group) | Present | Present | Present | Present |
| | Carboxy group | — | — | — | — |
| | (Meth)acryloyl group | — | — | — | — |
| Thickness of layer (μm) | | 1 | 1 | 1 | 1 |
| Adhesive layer | | Absent | Absent | Absent | Absent |
| Anti-mold-adherence layer | | Absent | Absent | Absent | Absent |
| Accumulated light volume of radiation (ML/cm²) | | 500 | 500 | 500 | 500 |
| Evaluation | Tensile elongation (%) | B | A | B | A |
| | Pencil hardness | H | H | H | H |
| | Tight contact | 100/100 | 100/100 | 100/100 | 100/100 |
| | Abrasion-resistance (ΔE) | A | B | A | B |
| | Mold contamination (transfer) | A | A | A | A |
| | Releasability (stress suppression) | A | B | A | A |

TABLE 7

| | | | Example | Example | Example | Example | Example |
|---|---|---|---|---|---|---|---|
| No. | | | 9 | 10 | 11 | 12 | 13 |
| Multi-layered sheet-Surface layer-laminated mold resin | | | C-9 | C-10 | C-11 | C-12 | C-13 |
| Formulation (part(s) by mass) | Active energy ray- | Type | B-9 | B-10 | B-11 | B-12 | |
| | curable resin | Solid content | 100 | 100 | 100 | 100 | 100 |
| | Polymerization initiator | IRGACURE 127 | 0.8 | 0.8 | 0.8 | 0.8 | 0.8 |

| | | | | | |
|---|---|---|---|---|---|
| Total | 100.8 | 100.8 | 100.8 | 100.8 | 100.8 |

| Polysiloxane group | | Present | Present | Present | Present | Present |
|---|---|---|---|---|---|---|
| Thermally reactive group | Hydroxyl group | Present | Present | Present | Present | Present |
| | Epoxy group (glycidyl group) | Present | Present | — | — | — |
| | Carboxy group | — | — | Present | — | — |
| | (Meth)acryloyl group | — | — | — | — | Present |
| Thickness of layer (μm) | | 1 | 1 | 1 | 1 | 1 |
| Adhesive layer | | Absent | Absent | Absent | Absent | Absent |
| Anti-mold-adherence layer | | Absent | Absent | Absent | Absent | Absent |
| Accumulated light volume of radiation (ML/cm²) | | 500 | 500 | 500 | 500 | 200 |
| Evaluation | Tensile elongation (%) | A | A | A | A | A |
| | Pencil hardness | H | H | H | H | H |
| | Tight contact | 100/100 | 100/100 | 100/100 | 100/100 | 100/100 |
| | Abrasion-resistance (ΔE) | A | A | A | B | B |
| | Mold contamination (transfer) | A | A | A | A | A |
| | Releasability (stress suppression) | A | B | A | A | A |

TABLE 8

| | | | Comparative | Comparative | Comparative | Comparative |
|---|---|---|---|---|---|---|
| No. | | | Example 1 | Example 2 | Example 3 | Example 4 |
| Multi-layered sheet-Surface layer-laminated mold resin | | | C-14 | C-15 | C-16 | C-17 |
| Formulation (part(s) by mass) | Active energy ray-curable | Type | B-13 | B-14 | B-1 | — |
| | resin | Solid content | 100 | 100 | 100 | — |
| | Polymerization initiator | IRGACURE 127 | 0.8 | 0.8 | 0.8 | — |

| | | | | |
|---|---|---|---|---|
| Total | 100.8 | 100.8 | 100.8 | — |

| Polysiloxane group | | — | Present | Present | — |
|---|---|---|---|---|---|
| Thermally reactive group | Hydroxyl group | Present | — | Present | — |
| | Epoxy group (glycidyl group) | Present | — | Present | — |
| | Carboxy group | — | — | — | — |
| | (Meth)acryloyl group | — | — | — | — |
| Thickness of layer (μm) | | 1 | 1 | 1 | 1 |
| Adhesive layer | | Absent | Absent | Present | Absent |
| Anti-mold-adherence layer | | Absent | Absent | Absent | Absent |
| Accumulated light volume of radiation (ML/cm²) | | 500 | 500 | 500 | 500 |
| Evaluation | Tensile elongation (%) | A | A | A | A |
| | Pencil hardness | H | B | H | B |
| | Tight contact | 100/100 | 0/100 | 100/100 | 100/100 |
| | Abrasion-resistance (ΔE) | A | C | A | C |
| | Mold contamination (transfer) | C | A | C | C |
| | Releasability (stress suppression) | C | A | A | C |

TABLE 9

| | | | Example | Example | Example | Comparative |
|---|---|---|---|---|---|---|
| No. | | | 14 | 15 | 16 | Example 5 |
| Multi-layered sheet Surface layer-laminated mold resin | | | C-18 | C-19 | C-20 | C-21 |
| Formulation (part(s) by mass) | Active energy ray-curable | Type | B-12 | B-3 | B-1 | Olefin-based |
| | resin | | | | (Thin layer) | substrate |
| | | Solid content | 100 | 100 | 100 | |
| | Polymerization initiator | IRGACURE 127 | 0.8 | 0.8 | 0.8 | |

| | | | |
|---|---|---|---|
| Total | 100.8 | 100.8 | 100.8 |

| Polysiloxane group | | Present | Present | Present | |
|---|---|---|---|---|---|
| Thermally reactive group | Hydroxyl group | Present | Present | Present | |
| | Epoxy group (glycidyl group) | — | Present | Present | |
| | Carboxy group | — | — | — | |
| | (Meth)acryloyl group | Present | — | — | |
| Thickness of layer (μm) | | 1 | 1 | 0.1 | 1 |
| Adhesive layer | | Absent | Absent | Absent | Absent |
| Anti-mold-adherence layer | | Absent | Present | Absent | Absent |
| Accumulated light volume of radiation (ML/cm²) | | 200 | 500 | 500 | 500 |
| Evaluation | Tensile elongation (%) | A | A | A | A |
| | Pencil hardness | H | H | B | B |
| | Tight contact | 100 · 100 | 100/100 | 100/100 | — |
| | Abrasion-resistance (ΔE) | B | A | C | C |
| | Mold contamination (transfer) | A | A | A | C |
| | Releasability (stress suppression) | A | A | A | C |

The details of the abbreviations in Table 1 are as follows.

GMA: glycidyl methacrylate

AA: acryl acid

2-HEA: 2-hydroxyethyl acrylate

FM-0721: trade name, manufactured by JNC, 3-methacryloxy propyl dimethyl polysiloxane

MMA: methyl methacrylate

BA: butyl Acrylate

ABN-E: radical polymerization initiator, Azobis-2-methylbutyronitrile

MIBK: methyl isobutyl ketone

Karenz AOI: trade name, manufactured by Showa Denko K.K., isocyanatomethyl acrylate

IRGACURE 127: trade name, manufactured by BASF, polymerization initiator, 2-hydroxy-1-{4-[4-(2-hydroxy-2-methyl-propionyl)-benzyl]-phenyl}-2-methylpropane-1-one

While the illustrative embodiments of the present invention are provided in the above description, such is for illustrative purpose only and it is not to be construed restrictively. Modification and variation of the present invention that will be obvious to those skilled in the art is to be covered by the following claims.

### INDUSTRIAL APPLICABILITY

The multi-layered sheet and transfer material of the present invention can be suitably used for various mold resin industries.

### DESCRIPTION OF REFERENCE NUMERALS

1 multi-layered sheet
2 substrate sheet
3 thermally curable layer

1. A multi-layered sheet comprising:
a substrate sheet; and
a layer that is disposed on a surface of the substrate sheet and can be disposed on at least a part of a surface of a mold resin, wherein
the layer is an uppermost layer of the multi-layered sheet,
the layer includes a product of active energy ray-curable resin cured or half-cured by active energy ray, and
the layer has: a thermally reactive group that can react and thermally cure with a material component of the mold resin; and a polysiloxane chain.

2. The multi-layered sheet according to claim 1, wherein
the layer is a protective layer to protect the surface of the mold resin.

3. The multi-layered sheet according to claim 1, wherein the thermally reactive group is selected from a group consisting of a hydroxyl group, an epoxy group, a carboxy group, and a (meth)acryloyl group.

4. The multi-layered sheet according to claim 1, wherein
the active energy ray-curable resin contains (meth)acrylic resin having a thermally reactive group, polysiloxane side chain, and an active energy ray-curable group.

5. The multi-layered sheet according to claim 1, wherein
an epoxy equivalent of the active energy ray-curable resin is 1000 g/eq or more and 10000 g/eq or less.

6. The multi-layered sheet according to claim 1, wherein
the active energy ray-curable resin is a reaction product of an intermediate polymer and an active energy ray-curable group-containing compound, the intermediate polymer is produced by a reaction of an intermediate material component including a polysiloxane-containing compound and a thermally reactive group-containing compound, and
a glass transition temperature of the intermediate polymer is 0° C. or more and 70° C. or less.

7. The multi-layered sheet according to claim 1, wherein
a weight-average molecular weight of the active energy ray-curable resin is 5000 or more and 100000 or less.

8. The multi-layered sheet according to claim 1, wherein
a material component of the active energy ray-curable resin contains the polysiloxane-containing compound, and
a ratio of the polysiloxane-containing compound is, relative to a total amount of the material component of the active energy ray-curable resin, 0.10 mass % or more and 10.0 mass % or less.

9. A transfer material comprising the multi-layered sheet according to claim 1.

10. The transfer material according to claim 9 further comprising a peelable layer disposed on a surface of the layer of the multi-layered sheet.
